(19) United States
(12) Patent Application Publication
(10) Pub. No.: US 2010/0003431 A1
(43) Pub. Date: Jan. 7, 2010

(54) COMPOSITE MATERIALS

(76) Inventor: John Raybuck, Irvine, CA (US)

Correspondence Address: John Raybuck, 222 Tall Oak, Irvine, CA, 92603, US

(21) Appl. No.: 12/488,556

(22) Filed: Jun. 20, 2009

Related U.S. Application Data
(60) Provisional application No. 61/129,524, filed on Jul. 2, 2008.
(60) Provisional application No. 61/194,330, filed on Sep. 26, 2008.

(51) Int. Cl. B32B 1/02; B32B 5/16; B32B 3/12; B32B 27/32

(52) U.S. Cl. 428/34.2; 428/323; 428/324; 428/330; 428/331; 428/116; 428/523

(57) ABSTRACT

Composite materials having at least one of the following desirable properties is described. Such properties include: rigidity, printability, water-proofness, pliability, recyclable, thermochromic, antimicrobial, electrically conductive, compostable or biodegradability. The composite includes a filler-containing layer and a fiber-containing layer substantially coupled together continuously across the at least one surface of the layers. These composites maybe useful in various markets including, but not limited to, construction, packaging, shipping, consumer products and medical packaging. The inventive composites provide, advantages such as reduction of environmental footprint, improved mechanical properties, usefulness/cost ratio, reduction in material costs compared to prior art, and cosmetic performance are embodied in the present invention.

### CROSS-REFERENCE TO RELATED APPLICATIONS

This application claims the benefit of U.S. Provisional Application Nos. 61/129,524, filed Jul. 2, 2008; and 61/194,330, filed Sep. 26, 2008; the contents of all of which are hereby incorporated by reference in their entirety.

### FIELD OF THE INVENTION

The present invention relates to the field of composites. More particularly, the present invention relates to compositions, articles of manufacture and methods related to composites that are environmentally friendly.

### BACKGROUND OF THE INVENTION

Synthetic paper or papers made with polymers and other fillers are usually described as transparent to completely opaque plastic films that are printable, writable and water resistance. The synthetic paper market has been traditionally a niche market with high profits but only few major participants. Historically, labels have dominated the market for synthetic paper. They are manufactured through various processing methods.

Solid bleached sulfate or (SBS) is a premium paperboard grade that is produced from a furnish containing at least 80% virgin bleached wood pulp. It utilizes both hardwood and softwood fibers and is typically produced on Fourdrinier paperboard machines. Most bleached paperboard is coated with a thin layer of kaolin clay to improve its printing surface and is sometimes coated with polyethylene resin for wet strength in food packaging. Some major market segments for SBS include, medical, milk and juice gable top cartons, aseptic drink boxes, cosmetics boxes, frozen food boxes. Thinner bleached board grades that are less rigid and not usually manufactured for packaging are classified as bleached bristols. Coated bristols are used for paperback book covers, greeting cards, gift cards, postcards, and advertising cards, etc.

Coated unbleached Kraft Paper (CUK) has two major producers in the US; for example MeadWestvaco manufactures—Clay Natural Kraft (CNK®) and Graphic Packaging International manufacturers—Solid Unbleached Sulfate (SUS®). SUS is a superior strength paperboard grade that is produced from a furnish containing at least 80% virgin unbleached, natural wood pulp. Most unbleached or natural Kraft paperboard is coated with a thin layer of kaolin clay to improve its printing surface and may be also coated with polyethylene resin for wet strength food packaging. The major market segment for CUK is beverage carriers, frozen food packaging, milk cartons and pharmaceutical packaging.

Another class is recycled paperboard. Uncoated recycled paperboard is a multiply material and produced from 100% recovered fibers that are collected from post consumer, converting plants, scrap from paper manufacturing plants and other sources. Sometimes uncoated paperboard is produced with a top ply of white recovered fiber or is vat dyed for color. A few major market segments that use uncoated recycled paperboard are shoeboxes and composite containers.

Coated recycled paperboard is also a multiply material and produced from 100% recovered fibers that are collected in the same manner as the uncoated paperboard. Typically, coated recycled paperboard is coated with a thin layer of kaolin clay over a top ply of white recovered fiber to improve its printing surface. Coated recycled paperboard is also known as clay coated newsback (CCNB) and utilizes many types of recycled fibers. The major market segments that used coated recycled paperboard are laundry detergent packaging, paper goods, cake mix packaging, perfume boxes, cookie and cracker packaging, cereal boxes and other dry food packaging. Creating a packaging product that is both attractive to consumers and inexpensive to fabricate while also being sufficiently durable to meet the needs of retail and shipping use can be challenging.

### SUMMARY OF THE INVENTION

Accordingly, the present invention satisfies a need in the industry for retail and/or shipping packages that are durable, cost effective, and attractive to consumers in terms of appearance, touch, and breathability, while incorporating environmentally friendly, recyclable, biodegradable, and/or compostable materials. It also satisfies a further need for composites that are useful for forming packaging, attractive retail, display, and/or shipping products that are readily machinable either at the point of manufacture (e.g., via scoring, folding, die-cutting, pressure and thermo-forming) or the point of distribution (e.g., via cartoning and gluing).

The present invention relates to composite materials having at least one of the following desirable properties such as: rigidity, printability, water-proofness, pliability, durability, flexibility, breathability, recyclable, thermochromic, antimicrobial, electrically conductive, compostable and biodegradability.

The composite material of the present invention represents a new class of composite materials and may include at least one discrete layer, or multiple alternating layers of a filler-containing layer, for example, a ground filler-containing layer, held together substantially continuously by at least one thermoplastic material and a fiber-containing layer. As mentioned above, the composite may be useful in, for example, retail and/or shipping packages that are durable and cost effective while are also attractive to consumers in terms of appearance, touch, breathability, theft resistant, and waterproofness, while incorporating environmentally friendly, recyclable, compostable, and/or biodegradable materials.

Some environmentally friendly paper is made with small amounts of thermoplastic material and high amounts of fillers, so that neither toxic gas nor smoke may be produced when the paper is burned, and the paper produced is recyclable. In the present invention, a composite is invented that may include any amounts of a thermoplastic material with a corresponding amount of filler. The environmentally friendly composite of the present invention's recyclability, compostability or biodegradability may be imparted or enhanced through the addition of an inherently recyclable, compostable or biodegradable thermoplastic material or one that may be made recyclable, compostable or biodegradable through the addition of an additive.

In one aspect, the present invention relates to composite materials including a filler which may contribute to one or more of the following properties, for example, printability, pliability, water resistance, breathability, durability, flexibility, recyclability, biodegradablility, compostability, opacity and sewing properties (sewability).

In another aspect, the present invention further relates to composites including a biodegradable, compostable or recyclable binding agent or agents.

In a further aspect, the present invention relates to composites including an additive capable of transforming a non-biodegradable binding agent into a biodegradable binding agent. The additive may include any oxo-biodegradable additive such as D2W™ supplied by (Symphony Environmental, Borehamwood, United Kingdom) and TDPA® manufactured by EPI Environmental Products Inc. Vancouver, British Columbia, Canada may be present in an amount from about 0% to about 3% by weight.

In yet another aspect, the present invention relates to composites including an additive capable of enhancing the biodegradability of the composite.

In yet a further aspect of the invention, the present invention relates to composites including a mixture of binding agents that is both biodegradable and non-biodegradable.

In one embodiment, the present invention includes composite materials including at least two components, combined to achieve at least one of the desirable properties when either of which may or may not possess any of the desirable properties individually. For example, a breathable filler-containing layer may be combined with a fiber-containing layer that is neither breathable, nor is water-proof to create a breathable and water-proof composite.

In another embodiment, the present invention includes composite materials including at least two components, at least one of which possesses at least one of the desirable properties, and the components combined to form a composite having an enhanced desired property.

In yet another embodiment, the present invention includes at least one component having at least one of the desirable properties which is not diluted in the combination.

In a further embodiment, the present invention includes at least one component having at least one of the desirable properties and another component having at least another of the desirable properties and the combined material having at least the two stated properties.

In still yet another embodiment, the composite materials of the present invention combines the printability and pliability properties of a traditional synthetic paper with the rigidness or stiffness, for example, of certain inexpensive fibers, to form composite materials having at least two stated properties and may be useful in a multitude of packaging applications where coated paperboard, uncoated paperboard, folding boxboard, coated unbleached kraft paperboard, or solid bleached sulfate are generally used. In addition, these inventive composite combinations may also be more environmentally friendly, for example, they may be compostable, biodegradable, or recyclable, and may also include many other improvements over the aforementioned art. Ultimately, to move the future towards a more environmentally, and recycling friendly direction in a cost effective manner the present invention can go a long way in fulfilling it.

In one embodiment, the composite structure of the present invention includes at least two layers, one of which includes a filler-containing layer and another of which includes a fiber containing layer.

The fiber-containing layer may include at least one of natural and synthetic fibers, having a surface; and the filler-containing layer, for example, a ground filler-containing layer, may include a filler substantially continuously surrounded by a binding agent, for example, a thermoplastic material, the filler-containing layer is coupled to the fiber-containing layer substantially continuously across the surface of the fiber-containing layer.

In one exemplary embodiment, the filler-containing layer, for example, a ground filler-containing layer, as noted above, includes at least one filler and at least one binding agent present as a continuous phase in the layer. The binding agent may be present in the filler-containing layer at an amount of about, for example, 10-15% by weight of the layer, or as much as is needed to create a continuous phase. In one aspect, the composite has a pliability that may be increased over that of the fiber-containing layer alone or the filler-containing layer alone. In another aspect, the filler may have a density of less than about, for example, 3 g/cc, more for example, 2.5 g/cc.

In another exemplary embodiment, the composite may include at least two layers, one of which includes a filler-containing layer, for example, a ground filler-containing layer, another of which includes a fiber-containing layer. The filler-containing layer includes at least one filler, at least one binding agent present as a continuous phase in the layer and at least one agent or method for aiding in the dispersibility of the filler in the binding agent. The binding agent may be present in the filler-containing layer at an amount of about, for example, 10-15% by weight of the layer, or as much as is needed to create a continuous phase. In one aspect, the agent may be a coupling agent for coupling the filler to the binding agent and improving the dispersion of the filler in the binding agent. In another aspect, the filler may be pre-treated utilizing various known treatments to again improve dispersibility within the binding agent.

In a further exemplary embodiment, the composite may include at least two layers, one of which includes a filler-containing layer, for example, a ground filler-containing layer, another of which includes a fiber-containing layer, and an electrically conductive layer may be present above or beneath the filler-containing layer. The conductive layer may include electrically conductive tapes and films which may be formed of a conductively loaded resin-based material. The conductively loaded resin-based material may include micron-sized or submicron-sized conductive powder(s), conductive fiber(s), or a combination of conductive powder and conductive fibers in a base resin host or matrix. The percentage by weight of the conductive powder(s), conductive fiber(s), or a combination thereof may be between about 20% and about 50% of the weight of the conductively loaded resin-based composition. The micron-sized or submicron-sized conductive powders may be formed from non-metals, such as carbon, or graphite, that may or may not be metallically plated, or the like, or from metals such as stainless steel, nickel, copper, silver, that may or may not also be metallically plated, or the like, or from a combination of non-metal, plated, or in combination with, metal powders. For example, the micron-sized or submicron-sized conductive fibers which may be of nickel plated carbon fiber, stainless steel fiber, copper fiber, silver fiber, aluminum fiber, or the like, may be useful in the present invention.

In yet a further exemplary embodiment, the present composite may include at least two layers, one of which includes a filler-containing layer, for example, a ground filler-containing layer, another of which includes a fiber-containing layer, and one or both of the layers may include an additive that allows the composite material to become EMI (electromagnetic interference) shielded, for example, with the use of a material such as the trademarked “ElectriPlast™”. ElectriPlast™ is an electrically conductive resin based material that may be processed into a film, utilizing a micron-sized conductive material to create a material that is as electrically conductive as metal. The binding agent may be present in the filler-containing layer at an amount of about, for example, 10-15% by weight of the layer, or as much as is needed to create a continuous phase.

In yet another exemplary embodiment, the composite includes at least two layers, one of which includes a filler-containing layer, for example, a ground filler-containing layer, another of which includes a fiber containing layer and may also include an antimicrobial additive that allows the composite's surface to have antimicrobial properties. The antimicrobial additive may have a cationic charge that ruptures the cell wall on contact, which may result in physically killing the cell. Other useful antimicrobial agents may include those that may be covalently bonded with the substrate and may include polymer bound antimicrobial amphiphilic peptides. The binding agent may be present in the filler-containing layer at an amount of about, for example, 10-15% by weight of the layer, or as much as is needed to create a continuous phase. In one aspect, the filler-containing layer may be coated with an antimicrobial coating. In a further aspect, the filler-containing layer may be impregnated with an antimicrobial agent.

In still a further exemplary embodiment, the composites may include a plurality of layers, one of which includes a filler-containing layer, for example, a ground filler-containing layer, another of which includes a fiber containing layer, to form a multilayer structure. In one aspect, the plurality of layers may include more than one ground filler-containing layers. In another aspect, the plurality of layers may be provided, for example, by coextruding layers of filler-containing layers and or co-calendaring multiple layers together. In a further aspect, the plurality of layers may include more than one fiber-containing layer. In yet another aspect, the composition of the filler-containing layers or fiber-containing layers may be the same or different.

In still another exemplary embodiment, the composite may include at least two layers, one of which may include a synthetic paper-type material, a filler layer, for example, a ground filler layer, and a thermoplastic material substantially surrounding the synthetic paper, the filler layer or both, and another of which includes a fiber-containing layer. The synthetic paper may be made by various existing methods, combined with natural, renewable, recyclable, recycled, biodegradable or compostable fibers. Synthetic paper as used herein includes not only commercially available synthetic papers, but also other synthetic papers that may be more environmentally friendly. Synthetic papers or papers made with polymers and other fillers usually range from transparent to completely opaque films that are printable, and/or writable. They may also possess any or all of the following properties such as water resistance, tear resistance, waterproof, foldability, durability, flexibility, and sewing properties (sewability). They may also come in various thicknesses and are made from various polymer/filler mixtures with various processing methods. When combined with natural, renewable, recyclable, and recycled fibers, they may be made to possess appropriate mechanical properties to create an extremely useful pliable, machinable composite structure. In one aspect, the filler is being held together substantially continuously by the thermoplastic material. In another aspect, the filler-containing layer may include a filler and a binding agent bonded to a synthetic paper layer. In yet another aspect, the filler and synthetic paper are being held together by the thermoplastic material.

In still yet another exemplary embodiment, the present composite may include at least two layers, one of which includes a substantially transparent or semi-transparent filler-containing layer, for example, a ground filler-containing layer, another of which includes a fiber-containing layer. The filler-containing layer may include at least one filler and at least one binding agent present as a continuous phase in the layer. In one aspect, the binding agent may be substantially transparent to create a substantially transparent filler-containing layer by using fillers that are substantially small. In another aspect, the filler may be substantially transparent to create a semi-transparent filler-containing layer. In a further aspect, the filler and the binding agent may both be substantially transparent to create a substantially transparent filler-containing layer.

In still yet a further exemplary embodiment, the present composite may be breathable and may include at least two layers, one of which includes a filler-containing layer, for example, a ground filler-containing layer, another of which includes a fiber-containing layer. The breathable (moisture impermeable and vapor permeable) layer may be advantageous in some utilities, to impart breathability to materials. In one aspect, the breathable layer may be the filler-containing layer. In another aspect, the breathable layer may be coextruded with the filler-containing layer, or the composite, as a skin or surface. In a further aspect, the breathable layer may be coated onto the surface of the composite. In yet a further aspect, a breathable layer may be a separate layer, attached or bonded to the surface of the filler-containing layer or composite. In yet a further aspect, the composite may be porous with a breathable skin coextruded or bonded to the surface.

In yet still a further exemplary embodiment, the present composite may have antistatic properties and may include at least two layers, one of which includes a filler-containing layer, for example, a ground filler-containing layer, another of which includes a fiber-containing layer. The antistatic property may be imparted to the composite by adding an electrostatic discharge reduction additive to the filler-containing layer, for example, to reduce electrostatic charges commonly generated by friction. Adding this additive may also improve processability. A few antistatic additives are for example, fatty acid esters, ethoxylated amines, alkyl sulfonates, ethoxylated amine, ethoxylated alcohol, alkylsulfonate ethoxylated amines, diethanolamides, or other similar compounds, may be added at a concentration of about 0.1 to about 3% by weight of the layer.

In one aspect of the invention, the filler-containing layer may be, for example, a ground filler-containing layer, any synthetic paper-type material, or mixtures or combinations thereof, and an agent capable of substantially holding the filler together and present in a continuous manner. The agent may be any thermoplastic material or binder.

In another aspect of the invention, the filler-containing layer may be created through a weaving process, similar to the weaving process used to make various types of fabrics or even woven carbon fiber. The combined filler material and polymer is extruded into individual threads which are then woven together to form a sheet or matte. In some cases the woven fabric may be post calendered with heat and pressure to create a substantially non-porous synthetic paper. In another version, the extruded thread(s) are tensilized to increase their linear strength. Tensilizing stretches and densities the thread such that the tensilized thread has enhanced slip properties which reduces friction which may aid in processing of the finished product. In addition, tensilizing also enhances the suppleness and softness properties of the thread and final sheet or matte while simultaneously increasing the linear strength. This may allow for a reduction in thread thickness with increased mechanical properties, which may allow for a reduction in weight.

In yet another aspect of the invention, the incorporation of about 2 to about 5% nanoadditives may be used for upgrading resin physical properties, i.e., improving mechanical properties, providing higher stiffness and dimensional stability, barrier improvements, and electrical conductivity. Two types of nanoadditives most widely reported and first to be used commercially are nanoclays (a nano-size aluminate silicate material) and carbon nanotubes. Nanoclay is the nanoadditive most commonly used in polymer nanocomposites and has shown the broadest commercial viability due to their lower cost. Typically chemical modification with surface treatments is performed to achieve good dispersion and resin coupling to maximize benefits. Other nanoadditives include synthetic clays, polyhedral oligomeric silsesquioxane (POSS), inorganic nanotubes, and barium sulfate nanoparticles nano-silica. Natural fibers such as flax, hemp, etc, may also be added to improve mechanical properties.

In general, the thermoplastic material may be either recyclable, made from recycled materials, or renewable, compostable and/or biodegradable. According to one embodiment, the thermoplastic material may include a polymer that may be either recyclable, for example, a material that may be made from substantially recycled or recyclable material; natural or renewable material; a substantially compostable and/or biodegradable material; or mixtures thereof. According to another embodiment of the invention, the thermoplastic material may include any polymer that may be made to be either recyclable, substantially compostable and/or biodegradable in the presence of an additive. According to yet another embodiment, the thermoplastic material may include a mixture of a polymer that is either recyclable, substantially compostable and/or biodegradable and another polymer that is not either recyclable, substantially compostable and/or biodegradable.

In one aspect, the filler maybe in layer-form and may be bonded to one or more thermoplastic materials. In another aspect, the filler may be dispersed in the thermoplastic material. In a further aspect, the filler maybe coupled to the thermoplastic material by being sandwiched in between at least two layers of thermoplastic material. In this aspect, one of the layers may be a synthetic paper.

The ground filler maybe any filler having a particle size ranging from, for example, about 0.01 to about 50 microns, more for example, from about 0.01 to about 25 microns. The particle size ranges cited above may be average particle size ranges or the range may be the range of particle sizes in the composite. The ground filler may also be present in an amount of, for example, from about 50% to about 90% by weight, more for example, from about 60 to 85% by weight.

In one exemplary embodiment of the present invention, the composite material having a filler-containing layer held together continuously by at least one binding agent, such as a thermoplastic material, may be bonded to the fiber layer by the thermoplastic material. In another exemplary embodiment of the present invention, the filler-containing layer may be adhered to the fiber layer through a bonding agent such as an adhesive. In other exemplary embodiment of the present invention, the bonding agent and thermoplastic material maybe the same material. The bonding agent may also be film forming. In still other embodiments, the filler-containing layer may also be made to be heat sealable, on one or both surfaces. The thermoplastic material, the adhesive or the filler-containing layer may be natural, renewable, recyclable, recycled, heat sealable, compostable, or biodegradable.

The thermoplastic material may be present in any amount that may form a continuous phase with the filler present in the layer, as discussed above. For example, the amount of the thermoplastic material may be from about 10% to about 50% by weight, more for example, from about 15% to about 40% by weight.

In one aspect, the fibers may be natural or renewable. In another aspect, the fibers may be recyclable. In a further aspect, the fibers maybe compostable or biodegradable. In yet a further aspect, the fibers may be natural, renewable, recyclable and biodegradable at the same time.

The filler layer may be cast, extruded, calendared, extruded and calendared, or blown film. When a film having a more uniform caliper or a thinner caliper is desired, the calendaring process is typically more amenable to a material having higher density filler content. The film may also be processed in a blown-film apparatus, in order to achieve direct biaxial orientation directly from the melt due to the formation of a tube. The blown-film process is known in the art, as the double-bubble process. In the blown film process the annular tube is inflated as it leaves the extruder and is cooled with an air ring, prior to collapsing and winding. The double-bubble process first quenches the tube, it is then reheated and oriented by inflating it at a temperature above the glass transition temperature (Tg) of the film material, but below the crystalline melting point (if the polymer is crystalline) of the film material. The film may be subsequently oriented, either uniaxially or biaxially, using conventional equipment such as drawing on heated rollers or using a tenter-frame, or a combination thereof. The processing operation may also include crystallization (of the outer layers) and/or heat-setting of the film. The biaxially oriented film can also be subjected to additional drawing of the film in the machine direction, in a process known as tensilizing. Tensilizing stretches and densifies the film such that the tensilized film has enhanced slip properties which reduces friction which may aid in processing of the finished product. In addition, tensilizing also enhances the suppleness and softness properties of the film while simultaneously increasing its linear strength bi-axially. Tensilizing may also be accomplished uniaxially, thus giving linear strength in only one axis. The composites of the present invention maybe inherently printable and/or writable or they may be surface modified or treated to become printable and/or writable. These composites may be utilized in all areas now performed by non-recyclable or difficult to recycle materials, or replacing materials having poor printability, such as material made from only recycled fibers, or material made from new trees that have been bleached and materials made from recycled fibers that have been surface treated with clay. The new composites may also be either inherently printable and/or may be surface modified to become printable. When a commercially available synthetic paper is used, it is inherently printable.

Other properties of the composite may also be adjusted by varying the amount and/or type of thermoplastic material and/or filler.

The present invention further relates to useful composite structure(s) constructed from the inventive components mentioned above. When a synthetic paper is used, it has the added advantage of not only being inherently printable, but may also possess many variations of appropriate mechanical properties, such as pliablility, and machinability.

The present invention together with the above and other advantages may best be understood from the following detailed description of exemplary embodiments of the invention illustrated in the drawings below.

### BRIEF DESCRIPTION OF THE DRAWINGS

FIG. 1a shows an exploded cross-sectional side view of a pre-composite layer having an independent ground filler-containing layer and fiber-containing layer according to one embodiment of the present invention;

FIG. 1b shows, an unexploded cross-sectional view of a composite in the side view, having a fiber-containing layer and a ground filler-containing layer covering the fiber-containing layer according to one embodiment of the present invention;

FIG. 1c shows, an unexploded cross-sectional side view of a multilayer composite, having a fiber-containing layer and a ground filler-containing layer covering the fiber-containing layer on both top and bottom according to one embodiment of the present invention;

FIG. 2a shows an isometric cross sectional view of a honeycomb sandwich composite structure according to one embodiment of the invention;

FIG. 2b shows an isometric cross sectional view of a corrugated core composite structure according to one embodiment of the invention;

FIG. 3 shows a cross sectional view of a corrugated composite structure according to one embodiment of the invention;

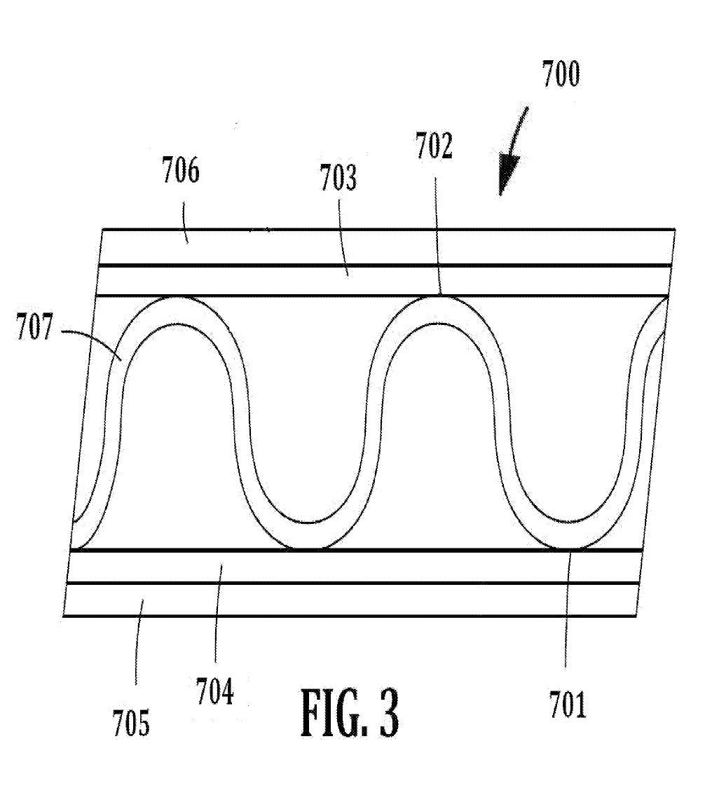

FIG. 4 shows, in perspective view, shows a shipping or retail box according to one embodiment of the invention;

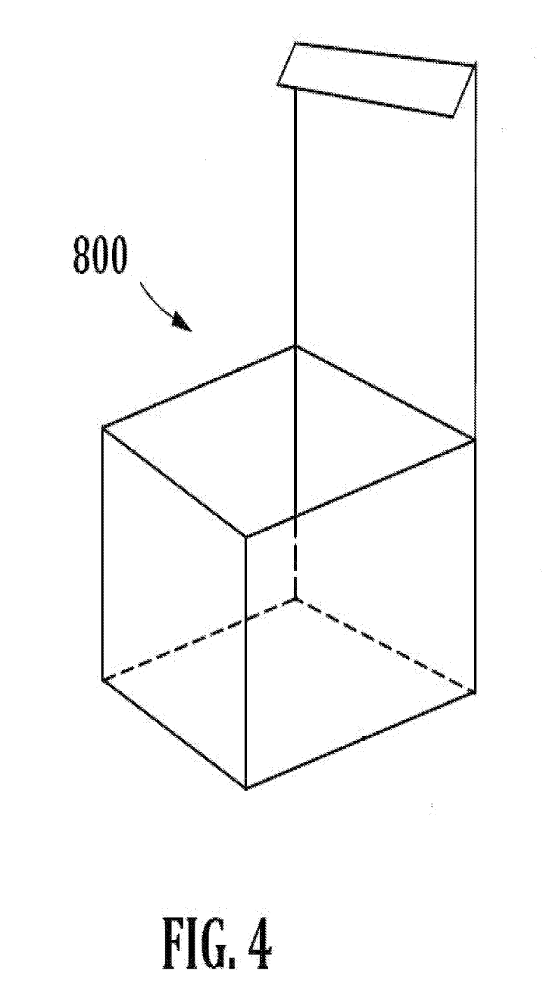

FIG. 5 shows an isometric view of an envelope or shipping mailer according to one embodiment of the invention;

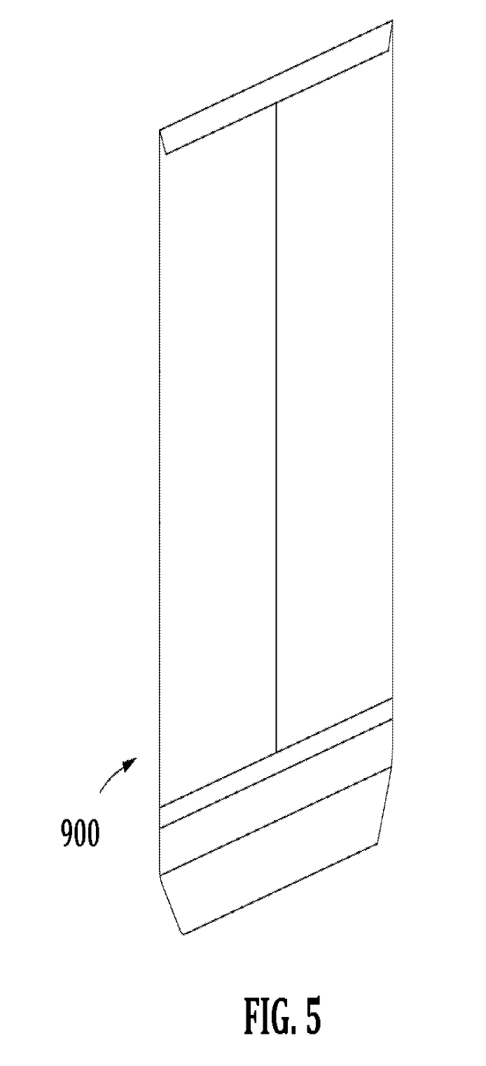

FIG. 6 shows the process steps in forming a honeycomb core structure according to one embodiment of the invention;

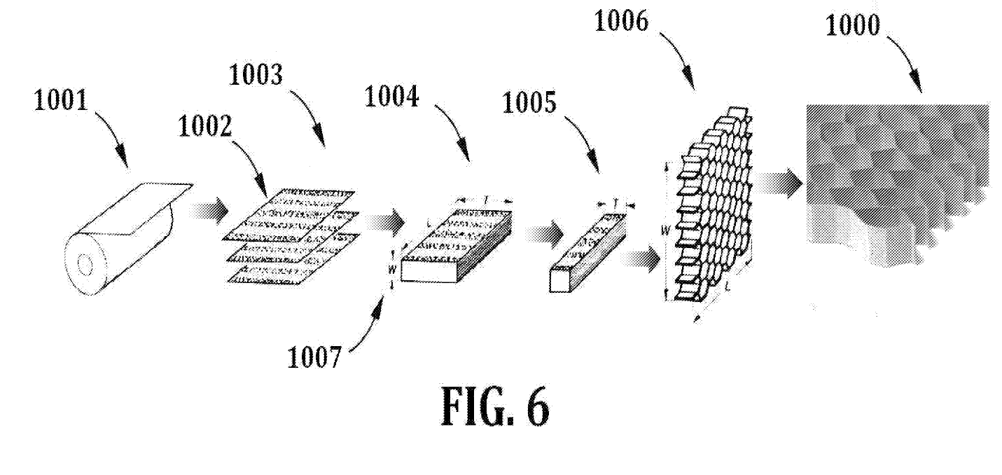

FIG. 7 shows alternative process steps in forming a honeycomb core structure according to yet another embodiment of the invention;

FIG. 8 shows the process steps in forming a corrugated core structure according to one embodiment of the invention;

FIG. 9 shows an isometric view and exploded view of a container according to one embodiment of the invention;

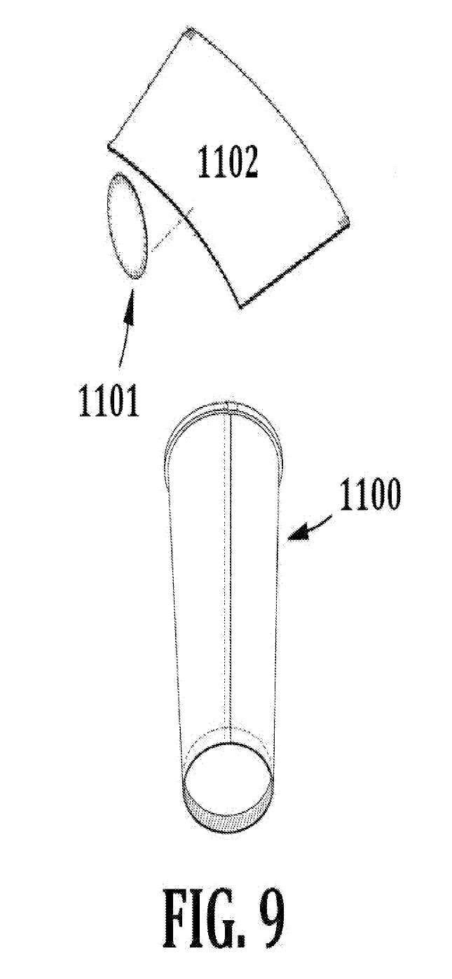

FIG. 10 shows an isometric view of a tube according to one embodiment of the invention; and

FIG. 11 shows a top view of a fabric layer according to one embodiment of the invention.

### DETAILED DESCRIPTION OF THE INVENTION

The detailed description set forth below is intended as a description of the presently exemplified composites provided in accordance with aspects of the present invention and is not intended to represent the only forms in which the present invention may be prepared or utilized. The description sets forth the features and the steps for preparing and using the composites of the present invention. It is to be understood, however, that the same or equivalent functions and ingredients incorporated in the composites may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described herein may be used in the practice or testing of the invention, the exemplified methods, devices and materials are now described.

All publications mentioned herein are incorporated herein by reference for the purposes of describing and disclosing, for example, the compositions and methodologies that are described in the publications which might be used in connection with the presently described invention. The publications listed or discussed above, below and throughout the text are provided solely for their disclosure prior to the filing date of the present application. Nothing herein is to be construed as an admission that the inventors are not entitled to antedate such disclosures by virtue of prior invention.

As used herein, a “composite” refers to an engineered material that is made from at least two components having different physical characteristics, each component may substantially retain its own identity by remaining separate and distinct on a macroscopic level within the finished composite while contributing to the desirable properties of the combination. In one aspect, the desirable properties of the combination may or may not be attainable by each component on its own. In another aspect, the desirable properties may be the sum additive of that of each component in the combination. In yet another aspect, the combined desirable properties may be greater than the otherwise additive contribution of each component.

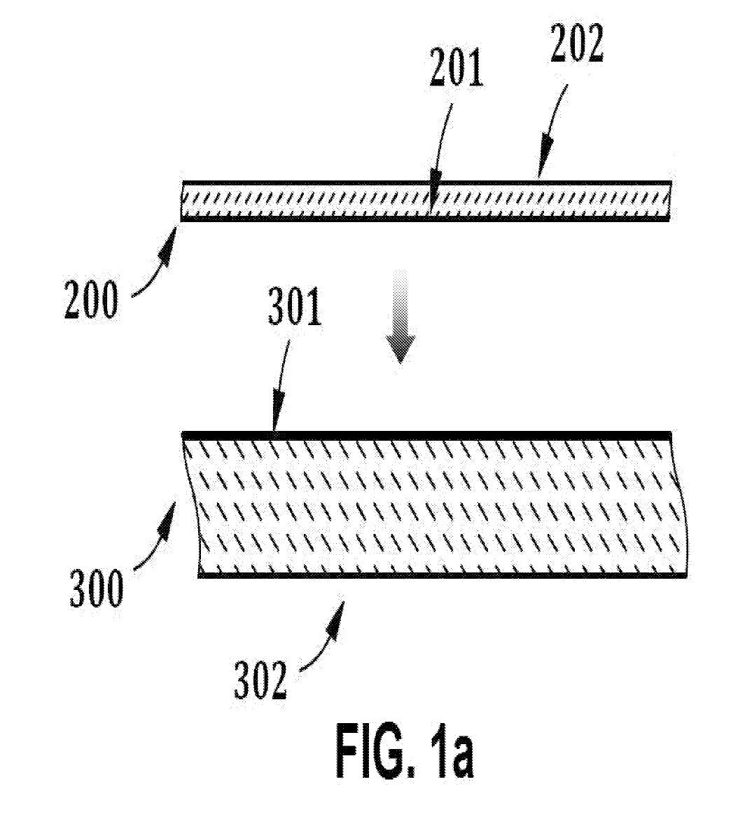

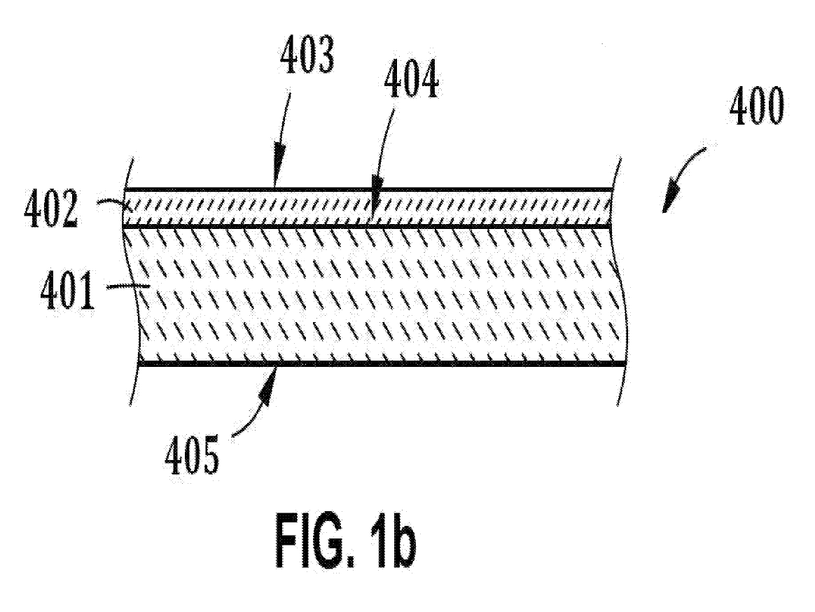

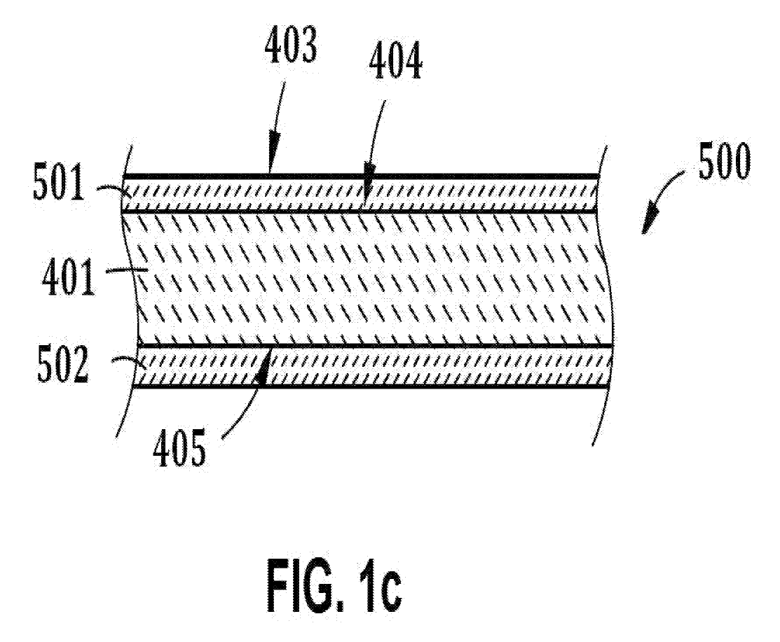

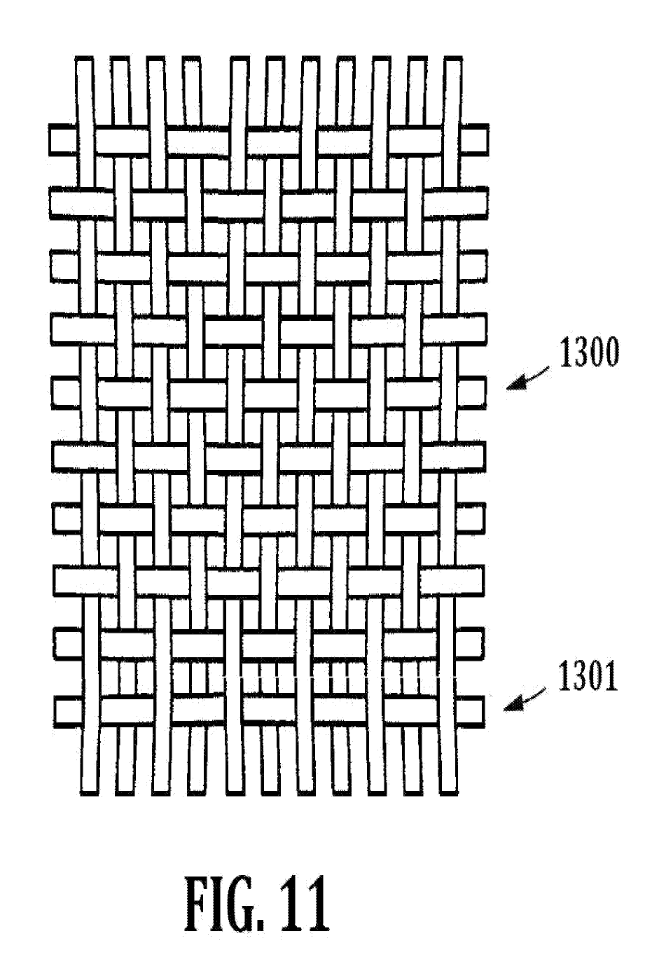

In making a composite material, parameters that may be controlled to achieve the improved composite structure 400, as shown in FIG. 1b, having the desired aesthetic and pliability characteristics, as well as desired durability and machinability. A composite material may include a filler-containing layer, for example, a ground filler-containing layer 200, as shown in FIG. 1a and/or a woven filler-containing layer 1300, as shown in FIG. 11, which may be formed and controlled by, for example, any or combinations of the following: the molecular weight of the binding agent, molecular weight distribution of the binding agent, the type of thermoplastic polymer utilized as the binding agent, coupling agent(s), particle size of the filler, particle size distribution of the filler, filler hardness, type of filler utilized, combinations of fillers utilized, filler structure, filler bulk density, filler lamellarity, amount of filler and binding agent, processing additives such as waxes and lubricants, post surface treatment(s) of layer 200, pretreatment of the fillers prior to combining them into the mixture, processing method for creating of layer 200, processing parameters and processing additives of layer 402, as shown in FIG. 1b, can all be modified individually or collectively in composite structure 400.

Materials having a tensile strength within a specified range are capable of being processed by paperboard machining equipment, such as automated folding, scoring, die-cutting and forming machines, to create final geometries. In contrast, materials that are lacking in proper tensile strength characteristics may be too brittle or stiff, or alternatively too elastic, to be machined in standard paperboard machining processes.

The properties of the fiber layer, such as a fiber layer 300, for example, as shown in FIG. 1a, may be controlled by any or combinations of the following: thickness of the layer, the fiber type, tensile strength of the fiber, fiber orientation, fiber density, and fiber length for the desired mechanical properties. As such, by combining layers 200 and 300 to become layers 402 and 401, respectively, of composite structure 400, as shown in FIG. 1b, and by additionally controlling the overall final composite structure's manufacturing process, also may affect the final mechanical properties of composite structure 400.

In one embodiment of invention, the composite structure 500, as shown in FIG. 1c, a ground filler-containing layer 501 is coupled to a fiber-containing layer 401 at surface 404, or, a ground filler-containing layer 501 may be coupled to fiber-containing layer 401 at surface 405 to form a pliable, machinable composite. This allows for both sides of the composite to be water proof, printable, and have good tear resistance, for example. This composite structure has many advantages and may be used for example, gift cards, greeting cards, maps, flyers, honeycomb cores, corrugated panels and others at lower cost and more environmentally friendly than those in the existing art.

In another embodiment of the invention, the composite structure 500, and layer 401 may be made from extruded, for example, woodflour, and/or a ground filler combined together with a thermoplastic polymer continuous layer, for example, to increase the stiffness to thickness ratio of layer 401 such that the composite may have the appropriate thickness, water-proofness and rigidity to be utilized for magnetic card keys, for example, the card keys utilized to open up a hotel room door or for a gift card at a lower cost and more environmentally friendly than traditional PVC or completely thermoplastic cards.

In one embodiment, the composition of the ground filler-containing layer 402, as exemplified in FIG. 1b, may be controlled to provide the composite structure 400 having the desired characteristics. The ground filler-containing layer 402 may include, for example, from about 10% to about 90%, more for example, 50% to about 90% by weight of a filler in the form of particles sized from about 0.01 microns to about 25 microns. Jet milling, standard milling, grinding and classification may help to control the particle size and distribution of the final filler during filler processing/production. Some of the advantages of utilizing the filler(s) are that they typically reduce anisotropic shrinkage, reduce overall shrinkage, are typically abundant, are environmentally friendly and are typically less expensive than the thermoplastic binding agent(s). Sometimes it may be desirable to pre-treat the fillers before combining them with the polymers for better dispersability.

The filler contained within the filler-containing layer 402 may be obtained from a multitude of suppliers and sources from around the world. Some examples of fillers that could be utilized as the filler within the ground filler-containing layer 402 are as follows: wollastonite, hydrated and non hydrated magnesium silicate—(Talcum, Soapstone, Steatite), Barium Sulfate—(Baryte, Blanc Fixe), barium ferrite, magnesium hydroxide (such as Brucite), magnesium carbonate—(Magnesite), aluminum trihydroxide, aluminum hydroxide, natural silica or sand, (Cristobalite, Diatonite, Novaculite, Quartz Tripoli), clay-calcined, muscovite, nepheline-syenite, feldspar, calcium suphate—(Gypsum, Terra Alba, Selenite), cristobalite, dolomite, silton, mica, hydratized aluminum silicates, coke, carbon black, pecan nut flour, wood flour, fly ash, starch, titanium dioxide, barium carbonate, terra alba, selenite, feldspar, nepheline-syenite, muscovite, pectolite, chrysotile, borates, and sulfates.

The filler-containing layer 402 further may include a binding agent, such as a thermoplastic polymer, that provides the continuous phase of layer 402. In one version, a type and prescribed amount of the thermoplastic polymeric binding agent may be added to the filler-containing layer 402 in sufficient amounts to provide a composite structure 400 that has a desired level of pliability, while also being readily machinable. In one example the filler may be added to the binding agent by pre-compounding them into pellets through extrusion to have the desired levels of filler/binding agent and additives, if added, in the pellets. Next the pellets may be processed, for example, through extrusion, calendaring, blown film extrusion or extrusion and then calendaring, into the desired form.

For example, useful binding agents may include polymers of monoolefins and diolefins, e.g. polypropylene, polyisobutylene, polybut-1-ene, poly-4-methylpent-1-ene, polyvinylcyclohexane, polyisoprene or polybutadiene, and polymers of cycloolefins, e.g. of cyclopentene or norbornene, polyethylene (which may optionally be crosslinked), e.g. high density polyethylene (HDPE), medium density polyethylene (MDPE), low density polyethylene (LDPE), linear low density polyethylene (LLDPE), (VLDPE) and (ULDPE); copolymers of monoolefins and diolefins with one another or with other vinyl monomers, e.g. ethylene/propylene copolymers, linear low density polyethylene (LLDPE) and blends thereof with low density polyethylene (LDPE), propylene/but-1-ene copolymers, propylene/isobutylene copolymers, ethylene/but-1-ene copolymers, ethylene/hexene copolymers, ethylene/methylpentene copolymers, ethylene/heptene copolymers, ethylene/octene copolymers, ethylene/vinylcyclohexane copolymers, ethylene/cycloolefin copolymers (e.g. ethylene/norbornene, such as COC), ethylene/1-olefin copolymers, the 1-olefin being produced in situ; propylene/butadiene copolymers, isobutylene/isoprene copolymers, ethylene/vinylcyclohexene copolymers, ethylene/alkyl acrylate copolymers, ethylene/alkyl methacrylate copolymers, ethylene/vinyl acetate copolymers or ethylene/acrylic acid copolymers and salts thereof (ionomers) and terpolymers of ethylene with propylene and a diene, such as, for example, hexadiene, dicyclopentadiene or ethylidenenorbornene; homopolymers and copolymers that may have any desired threedimensional structure (stereostructure), such as, for example, syndiotactic, isotactic, hemiisotactic or atactic Stereoblock polymers are also possible; polystyrene, poly(p-methylstyrene), poly(alpha-methylstyrene); aromatic homopolymers and copolymers derived from vinylaromatic monomers, including styrene, alpha-methylstyrene, all isomers of vinyltoluene, in particular p-vinyltoluene, all isomers of ethylstyrene, propylstyrene, vinylbiphenyl, vinylnaphthalene and vinylanthracene and blends thereof, homopolymers and copolymers may have any desired three-dimensional structure, including syndiotactic, isotactic, hemiisotactic or atactic, stereoblock polymers; copolymers, including the abovementioned vinylaromatic monomers and comonomers selected from ethylene, propylene, dienes, nitriles, acids, maleic anhydrides, maleimides, vinyl acetates and vinyl chlorides or acryloyl derivatives and mixtures thereof, for example styrene/butadiene, styrene/acrylonitrile, styrene/ethylene (interpolymers), styrene/alkylmethacrylate, styrene/butadiene/alkyl acrylate, styrene/butadiene/alkyl methacrylate, styrene/maleic anhydride, styrene/acrylonitrile/methyl acrylate; blends having a high impact strength and comprising styrene copolymers and other polymers, e.g. polyacrylates, diene polymers or ethylene/propylene/diene terpolymers; and block copolymers of styrene, such as, for example, styrene/butadiene/styrene, styrene/isoprene/styrene, styrene/ethylene/butylene/styrene or styrene/ethylene/propylene/styrene. Hydrogen-saturated aromatic polymers derived by hydrogen saturation of said polymers, in particular including polycyclohexylethylene (PCHE) prepared by the hydrogenation of atactic polystyrene (frequently designated as polyvinylcyclohexane (PVCH)); polymers derived from alpha,beta-unsaturated acids and derivatives thereof, such as, for example, polyacrylates, polymethacrylates, polymethyl methacrylates, polyacrylamides and polyacrylonitriles, made impact-resistant with butyl acrylate, copolymers of said monomers with one another and with other unsaturated monomers, such as, for example, acrylonitrile/butadiene copolymers, acrylonitrile/alkyl acrylate copolymers, acrylonitrile/alkoxyalkyl acrylates or acrylonitrile/vinyl halide copolymers or acrylonitrile/alkyl methacrylate/butadiene terpolymers; polymers derived from unsaturated alcohols and amines or from acyl derivatives or acetals thereof, for example polyvinyl alcohol, polyvinyl acetate, polyvinyl stearate, polyvinyl benzoate, polyvinyl maleate, polyvinyl butyral, polyallyl phthalate or polyallylmelamine; and copolymers thereof with olefins; homopolymers and copolymers of cyclic ethers, such as, for example, polyalkylene glycols polyethylene oxide, polypropylene oxide or copolymers thereof with bisglycidyl ethers; polyacetals, such as, for example, polyoxymethylene and those polyoxymethylenes which contain ethylene oxide as a comonomer, polyacetals modified with thermoplastic polyurethanes, acrylates or MBS; polyamides and copolyamides derived from diamines and dicarboxylic acids and/or from aminocarboxylic acids or the corresponding lactams, for example polyamide 4, polyamide 6, polyamide 6/6, 6/10, 6/9, 6/12, 4/6, 12/12, polyamide 11, polyamide 12, aromatic polyamides starting from m-xylenediamine and adipic acid; polyamides prepared from hexamethylenediamine and isophthalic and terephthalic acid as starting materials and with or without an elastomer as a modifier, for example poly-2,4,4-trimethylhexamethyleneterephthal-amide or poly-m-phenyleneisophthalamide; and also block copolymers of said polyamides with polyolefins, olefin copolymers, ionomers or chemically bonded or grafted elastomers; polyamides with polyethers, for example with polyethylene glycol, polypropylene glycol or polytetramethylene glycol; and also polyamides or copolyamides modified with EPDM or ABS; polyamides condensed during the preparation (RIM polyamide systems); polyesters derived from dicarboxylic acids and diols and/or from hydroxycarboxylic acids or the corresponding lactones, for example polyethylene terephthalate, polybutylene terephthalate, poly-1,4-dimethylolcyclohexane terephthalate, polyalkylene naphthalate (PAN) and polyhydroxybenzoate, and also block copolyetheresters derived from hydroxyl-terminated polyethers; polycarbonates and polyestercarbonates, polyketones, polysulfones, polyethersulfones and polyetherketones; crosslinked polymers derived from aldehydes on the one hand and phenols, ureas and melamines on the other hand, such as, for example, phenol/formaldehyde resins, urea/formaldehyde resins and melamine/formaldehyde resins; unsaturated polyester resins derived from copolyesters of saturated and unsaturated dicarboxylic acids, polyhydric alcohols and vinyl components as crosslinking agents, and also halogen-containing modifiers thereof having low flammability; crosslinked acrylic resins derived from substituted acrylates, e.g. epoxyacrylates, urethaneacrylates or polyesteracrylates; starch; polymers and cocopolymers of materials such as ploylactic acids and its copolymers, cellulose, polyhydroxy alcanoates (PHA), polycaprolactone (PCL), polybutylene succinate (PBS) polymers and copolymers of N-vinylpyrrolidone such as polyvinylpyrrolidone, poly(vinylpyrrolidone-co-vinyl acetate), and crosslinked polyvinylpyrrolidone, Ethylene Vinyl Alcohol (EvOH).

More for example, examples of thermoplastic polymers that may be suitable as binding agents may include the following: Polypropylene, High Density Polyethylene, Polyolefin combined with MS0825 Nanoreinforced® POSS® Polypropylene, thermoplastic elastomers, thermoplastic vulcinates, Polyvinylchloride, Polylactic acid, Polyester, unsaturated polyesters, acrlynitrilebutadiene styrene, Polyoxamethalyne, Cellulosics, Polyamides, Polyamideimides, ionomer, Polycarbonate, Polybutylene terephthylate, Polyester elastomers, Linear low density polyethelene, thermoplastic polyurethane, cyclic olefin copolymer, bi-axially oriented polypropylene, ethylene copolymers, various biodegradable polymers such as Cereplast-Polylactic Acid, Purac-Lactide® PLA, Nec Corp PLA, Mitsubishi Chemical Corp GS PLA resins, Natureworks LLC PLA, Cereplast-Biopropylene®, Spartech®-PLA Rejuven8 Plus, resins made from starch, cellulose, polyhydroxy alcanoates (PHA), polycaprolactone (PCL), polybutylene succinate (PBS), or combinations thereof, such as Ecoflex F BX 7011 and Ecovio L Resins from BASF, Germany, Polyvinylchloride, and recycled and reclaimed Polyester such as recycled soda bottles, Ecoflex F BX 7011 from BASF, Germany, and Nodax®—biodegradable polyester made by P&G of Cincinnatti Ohio.

The binding agent(s) may be provided in an amount of, for example, from about 10% to about 50% by weight of the layer 402, more for example, from about 10% to about 25% by weight, and even more for example, from about 10% to about 15% by weight. At the level of about 10% to about 15%, the composite structure 400 may be readily pressure formable. It is contemplated that higher amounts of binding agent, such as amounts of at least 30% by weight, may be provided to render the composite structure 400 more readily vacuum thermoformable.

To achieve a desired stiffness, pliability and/or printability of the resulting structure 400, the molecular weight of the binding agent, molecular weight distribution of the binding agent, the type of thermoplastic polymer utilized as the binding agent, coupling agent(s), if present, particle size of the filler, particle size distribution of the filler, filler hardness, type of filler utilized, combinations of fillers utilized, filler structure, filler density, amount of filler and binding agent, post surface treatment(s) of layer 200, if done, pretreatment of the fillers prior to combining them into the mixture, if done, processing method for creating of layer 200, processing parameters and processing additives of layer 402, etc, may all be modified.

The pliability of the composite is generally higher than that of the fiber-containing layer alone. For example, The composite may have a pliability of at least 15% higher than that of the fiber-containing layer alone, more for example, at least about 20% higher than that of the fiber-containing layer alone, even more for example, higher than about 25% of the fiber-containing layer alone. In one specific example, the pliability of the composite may be at least 18% higher than that of the fiber-containing layer alone.

The density of both the ground filler-containing layer 402 and fiber-containing layer 401 may be selected to allow for the ease of machinability in standard paper and paperboard machines. If the final composite structure is too light or too heavy, it may not allow for the ease of scoring, folding, gluing, die-cutting, and cartoning on common/standard machines. Modifications to existing machines or even the creation of custom machines may be developed to process materials outside of a particular mechanical range. It is contemplated that the present invention also includes composites they may need new or modified equipment to process materials outside the typical range, if materials outside of the typical range may be more advantageous for a particular application.

For example, a suitable basis weight of ground filler containing layer 402 may be from about 10 to about 250 lbs/1000 sqft, a density of from about 50 to about 900 g/m², and a thickness of from about 1.0 to about 35 mils.

Also, for example, a suitable basis weight of the fiber-containing layer 401 may be from about 50 to about 130 lbs/1000 sqft, a density of from about 200 to about 430 g/m^{2,} a thickness of from about 10 mil to about 30 mils, and a tensile strength of from about 125 to about 900 MD and about 55 to about 400 CD.

To those familiar with the art, box boards, kraft boards and recycled boards all have typical processing tensile strength characteristics in the machine direction as well as cross-direction. Typical tensile strengths may be measured utilizing ASTM D5342-97. For typically machine processable standard box boards, kraft boards and recycled boards, they have a tensile strength of from about 125 to about 900 MD, and from about 55 to about 400 CD. A suitable paperboard layer, such as a triplex composite 500 or duplex composite 400, as shown in FIGS. 1c and 1b, respectively, the paperboard layer has a tensile strength as measured by ASTM D5342-97 Standard, of from about 140 to about 685 MD. Materials outside of this range may be either too stiff or alternatively too elastic to be machined and or processed on common paperboard machines known to those in the art. It is desired that composite structures 400 and 500 may also share these mechanical characteristics so that they may also be easily processed on common paperboard machinery.

Table A below outlines various suppliers and tradenames that may provide or manufacture fillers that could be utilized in the filler-containing layer 402.

As mentioned above, the composite material 400 or 500 may also have antimicrobial properties. Antimicrobial agents may include, but are not limited to, antibiotics such as Acticide manufactured by Thor Specialties in the United Kingdom, Troysan ALG manufactured by Troy Chemei GmbH, Germany (methylthio-cyclopropylaminotert-butylamino-sym-triazine), Vanquish, manufactured by Zeneca Biocides (N-butyl benzisothiazoline), 10,10′-oxybisphenoxarsine (OBPA), isothiazolone, silver ions on zeolite, β-lactams (e.g. penicillin), aminoglycosides (e.g. streptomycin) and tetracylcines (e.g. doxycycline), antimycotics such as polyene drugs (e.g. amphotericin B) and imidazole and triazole drugs (e.g. fluconazole), and general antimicrobial agents such as silane based antimicrobial additives, various metals and compounds, such as sodium omadine, sodium borate, sodium 2-mercaptobenzothiazole, potassium n-hydroxymethyl-n-methyldithiscarbamate, calcium borate, barium metaborate, zinc omadine, zinc borate, zinc dimethyldithiocarbamate, zinc 2-mercaptobenzothiazole, zinc 2-pyridinethiol-1-oxide, other transition metals and silver-based additives,iodo alkynyl alkyl carbamates, diiodomethyl-p-tolylsulfone, 2-4-thiazolyl-benzimidaxole, 2-n-octyl-4-isothiazolin-3-one, 5-hydroxyemthoxymethyl-1-aza-3,7-dioxa-bicyclooctane, 2,3,5,6-tetra-chloro-4-pyridine, and N-trichloromethylthiophthalimide, tetrachloroisophthalonitrile, deltamethrin, fipronil, bifenthrin, chlorfenapyr, imidacloprid, and mixtures thereof, quaternary ammonium cations (e.g. benzalkonium chloride or cetylpyridinium chloride (CPC)) and compounds such as triclosan and chlorhexidine; and others.

Examples of some silane based antimicrobial agents may include Biosafe-Silane based antimicrobial additive that may be masterbatched silane-based technology to render plastics inherently antimicrobial. Such technology may be more cost-effective and faster-acting than silver-based additives, though silver-based additives may also be used. The active ingredient of these antimicrobial agents in masterbatches may only need to be at a level to generate about 0.25 to about 0.5% by weight loading in the final product to be effective, again making it a more competitive, safe and efficient additive than traditional antimicrobials such as silver or triclosan. Also, unlike silver, which can sometimes cause yellowing or tarnishing, silane-based antimicrobials may also improve colorability and lessen the possibility of compromising optical properties when used with high-clarity resins, if such is desired.

Other useful antimicrobial agents may include those that may be covalently bonded with the composite material. For example, quaternary ammonium cations, such as N-alkyl-pyridiniums, may be used as antimicrobial moieties in covalently attached polymeric surface coatings. In one case, poly(4-vinyl-N-hexylpyridinium) (N-alkylated-PVP) was previously noted to have an optimum alkyl side chain length for antimicrobial activity. The side chain length of the alkyl group may, for example, vary from 0 (to side chain) to 12 carbons long, more for example from 5 to 7 carbons long.

The alkyl side chains may provide increased hydrophobicity for the coating and may promote association with microbial membranes. Polyethylenimine (PEI) was also previously used as a bacteriocidal coating when both N-alkylated on its primary amino group and subsequently N-methylated on its secondary and tertiary amino groups to raise the overall number of cationic quaternary amino groups. An increased number of cationic groups (permanently charged or charged due to the pH of the system) may promote an electrophoretic mechanism when associated with microbial membranes, which may promote the lysis of the microbe. Any such covalently bonded quaternary ammonium cation polymeric coatings may be used to give an antimicrobial property to the composite.

The antimicrobial agents may be present as a coating or the composites may be impregnated with the agents, especially if the composite is porous and/or breathable. The coating method or methods of impregnation may be any suitable known methods, using any suitable solvents including water.

Antimicrobial coatings may be covalently attached to the surface by a variety of methods and may include, for example, creating suitable reaction sites, such as free hydroxyl or amino groups, by coronal discharge, surface etching, hydrolyzation or other methods that disrupt the surface of the composite to create sites of suitable reactivity. The antimicrobial coatings may then be synthesized by reacting the various precursors with the prepared surface of the composites to build the proper coating. In other cases, silanes may be used as coupling agents to complex antimicrobial moieties to the composites.

TABLE A

| | |
|---|---|
| TradeName | Manufacturer |

Aluminum Hydroxide

| | |
|---|---|
| Martinal | Martinswerk GmbH, Bergheim, D |
| Apyral | Vereinigte Aluminiumwerke, Bonn, D |
| Baco | Alcan Chemicals, Bucks, UK |
| Securoc | Incemin AG, Holderbank, CH |

Barium sulphate

| | |
|---|---|
| Albaryt | Deutsche Baryt Industrie, Bad Lauterberg, D |
| Blanc fixe | Sachtleben Chemie, Duisburg, D |
| Huberbrite | J. M. Huber Corp., Havre de Grace, MD/USA |
| Blanc roc | Minerals Girona S.A., Figueres, E |
| Micro baryte | 20 Microns, Ltd., Baroda, IN |

Calcium sulphate

| | |
|---|---|
| LP #2 | Charles B. Chrystal Inc., New York, USA |

Dolomite

| | |
|---|---|
| Microdol | Mondo Minerals, Helsinki, SF |
| Heladol | Herbert Lange GMbH, Wittenborn, D |
| Myanit | Ernstrom Minerals AB, Malmo, S |
| Mikro-Dolomit | Blancs Mineraux de Paris, Chatour, F |

Feldspar

| | |
|---|---|
| Minex | Unimin Canada Ltd., Etobicoke, CAN |
| Treminex | Quarzwerke GmbH, Frechen, D |
| Syenex | North Cape Nefeline A/S, Oslo, N |

Kaolin

| | |
|---|---|
| Dorkafill | Gebruder Dorfner GmbH, Hirschau, D |
| Polarite | Ecc, St. Austell, UK |
| Satintone | Engelhard Corp., Iselin/NJ, USA |
| Polyfil Trefil | J.M. Huber Corp., Havre de Grace, MD/USA |

Talc

| | |
|---|---|
| Steamic | Luzenac Europe, Toulouse, F |
| Jetfine ® | Rio Tinto Minerals, Denver/CO, USA |
| M20 SL | Mondo Minerals, Helsinki |
| Talco HM2 | I.M.I. Fabi S.r.l., Milano, I |
| Supra | Golcha Talc, Jaipur, IN |
| Microtalc | 20 Microns, Baroda, IN |
| Talco 01 | Xilolite S.A., Sao Paulo, BR |
| Vantalc | R. T. Vanderbilt Co. Inc., Norwalk/CT, USA |
| Vertal ® | Luzenac America Inc., Englewood/CO, USA |
| Mistron ® | Luzenac America Inc., Englewood/CO, USA |

Wollastonite

| | |
|---|---|
| Tremin | Quarzwerke GmbH, Frechen, D |
| Vansil | R. T. Venderbilt Co. Inc., Norwalk Ct, USA |
| NYAD | Nyco Minerals Inc., Willsboro/NY, USA |
| Snowfort | Omya Croxton and Garry, Dorking, UK |

Woodflour

| | |
|---|---|
| Lignocel | J. Rettenmairer & Sohne GmbH, Holzmuhle, D |
| Jeluxyl | Jelu-Werk, Rosenberg, D |

Calcium carbonate, Natural

| | |
|---|---|
| Hydrocarb | Omya GmbH, Koln, D |
| Calcilit | Alpha Calcit, Koln, D |
| Calcit | Schon + Hippelein, Heidenheim, D |
| Mikhart | Provencale S.A., Brignoles, F |
| Microcarb | Reverte S.A., Barcelona, E |
| Polcarb | ECC, St. Austell, UK |
| Calcitec | Mineraria Sacilese S.p.A., Sacile, I |

Calcuim Carbonate Precipitated

| | |
|---|---|
| CCP | Kalkwerke Schaefer, Diez a.d. Lahn, D |
| Socal | Solvay GmbH, Solingen, D |
| Swinnofil | Zeneca Colours, Blackley, UK |

When selecting a filler or filler combination to create the filler-containing layer 402 in composite structure 400 or 500, the particle size, shape and opacity may be an an important consideration as well as the specific surface and particle packing. Fillers come in various shapes, for example, spherical, cubic, platy, acicular, and fibrous, etc. Usually the average particle size and top cut size—(particle sizes below which 50% and 98% of the particles fall according to Stokes Law) is not sufficient to estimate the impact of the particulate filler on the mechanical properties of a compound because extremely fine or coarse particles may alter the crystallinity of the continuous polymer phase or decrease impact strength, for example. Therefore, using the entire particle size distribution (PSD) curve may be the best way to select the filler size for the intended application. Particle size range for the filler-containing layer 402 is typically about 0.01 to about 50 microns, more example, about 0.01 to about 25 microns.

As discussed before, a substantially transparent filler-containing layer may be contemplated. As used herein, the term “substantially transparent” means having greater than 70% transmission of light at a specified wavelength or within a wavelength range. This may be possible with either a transparent binding agent, a transparent filler, and/or combinations thereof. With a transparent binding agent, a substantially transparent filler-containing layer may be possible even if the filler is not substantially transparent if the particle size of the filler is, for example, well-dispersed, is small, is nano-sized or combinations thereof. Examples of transparent binding agents may include, but are not limited to carboxypolymethylene, polyacrylic acid polymers and copolymers, hydroxypropylcellulose, cellulose ethers, salts of poly(methyl vinyl ether-co-maleic anhydride),amorphous nylon, polyvinylchloride, polymethylpentene, Methyl methacrylate-acrylonitrile-butadiene-styrene, acrylonitrile-styrene, polycarbonate, polystyrene, poly methyl methacrylate, polyvinyl pyrrolidone, poly(vinylpyrrolidone-co-vinyl acetate), polyesters, parylene, polyethylene naphthalate, ethylene vinyl alcohol, and polylactic acids.

With a transparent filler, a substantially transparent filler-containing layer may be possible even if the binding agent is not substantially transparent if the particles are well-dispersed so that a minimal amount of binding agent is needed. Examples of transparent ground fillers that may be utilized are, but are not limited to, as follows: Natrolight, Petalite, Phenakite, Quartz, Strontianite, Chrysoberyl, Rhombohedral calcite, Silica, Silicon oxide, Trona, fumed silica, treated or untreated, hydrophilic or hydrophobic, and Garamite®—(manufactured by Southern Clay Products, Inc) which is Mixed Mineral Thixotrope or (MMT) Technology. MTT Technology involves blending of acicular and platey minerals that are then surface modified for resin compatibility. The combination of different mineral morphologies promotes particle spacing to create a product that disperses easily. Garamite additives differ from other organically modified mineral thixotropes by exhibiting unparalleled ease of dispersion, ease of use, high efficiency, and high performance without unwanted viscosity. The opacitiy or transparency imparted by a filler may also be determined by the size and not necessary the composition. Nano-sized particles may tend to possess more transparency than larger particle sizes, as noted above.

There are advantages to a, transparent filler-containing layer 402 in that it may be reversed printed at surface 201 to protect the print, or graphics from scuffing, or from wear and tear when in use as in composite structure 400. This may be done by printing to occur before filler containing layer 200 is coupled to fiber-containing layer 300, as shown in FIG. 1a, creating layers 402 and 401, respectively, as shown in FIG. 1b. In an alternative version of layer 200, the composition of the ground filler-containing layer 402 may be made from fillers and thermoplastic binding agents that are transparent. Utilizing this method of reverse printing on surface 201 would protect the print by placing it opposite the exposed top surface 202 and reduce the amount of wear the print would experience since it would be protected by being between transparent filler containing layer 402 and the fiber-containing layer 401 at interface 404. The transparent ground filler-containing layer 402 may include from about 5% to about 90% by weight of transparent ground filler in the form of particles sized from about 0.01 to about 50 microns, more for example, about 0.01 to about 25 microns. In addition, one may also be able to print not only on the back side of the film but print on the front side of the film to create a three-dimensional holographic effect.

Generally, fillers having a density of less than about 3 g/cc, more for example, less than about 2.5 g/cc, even more example, less than about 2 g/cc, are useful in the present invention to create lower weight composites. For fillers with densities that are above 2.5, they may be combined with less dense fillers or less filler may be employed to create a lighter composite, if desired. Some examples of fillers include montmorillonite-silicates, hydrated sodium calcium aluminum silicate (1.7-2.7); Borax-Carbonates, Borates, Hydrated sodium borate (1.74); Ulexite-Nitrates, Carbonates, Borates, Hydrated sodium calcium borate (2.0); Kernite-Nitrates, carbonates, borates, Hydrated sodium borate (1.9); Bauxite-Oxides and hydroxides, hydrous aluminum oxides (2.3-2.7); Brucite-Oxides and hydroxides, magnesium hydroxide (2.4); Trona-Nitrates, carbonates, borates, hydrated sodium carbonate (2.17); Epsomite-sulfates, chromates, molybdats, tungstates, hydrated magnesium sulfate (1.67); Gypsum-sulfates, chromates, molybdates, tungstates, hydrated calcium sulfate (2.35) and so on. If higher density fillers are used alone, they may be in the amount of less than 50% by weight to keep the density of the filler-containing layer at the lower range, if desired. Some examples of higher density fillers may include talc, Calcium Magnesium carbonate, titanium dioxide, barium sulfate, Calcium Silicate anhydrous calcium sulfate and calcium carbonate.

In addition to having a thermoplastic polymer binding agent and filler(s) as the bulk of the filler-containing layer 402, in some instances, it is recognized that the filler-containing layer 402 may include, when desired, coupling agent(s) usually from about, for example, 0.1 to about 5%, more for example, 0.2% to about 3% by weight of the filler-containing layer, to help exfoliate the fillers into the thermoplastic matrix evenly and aid in the mixing and coupling of the filler to the polymer matrix, allowing the filler and binding agent to be miscible. In addition to the various method(s) of manufacture of filler-containing layer (402), it may include a coupling agent which may assist in helping to reduce extrusion pressures and die build-up if filler-containing layer 402 is extruded and/or which may also increase calendaring speeds. The following Titanate and Zirconate coupling agent examples from Ken-React® may be useful in assisting in the coupling of various fillers with polymers and to assist in the compound's manufacturability through the various processing equipment and also improve mechanical properties of the final mixture. Below are a few examples of the fillers combined with various Ken-React® grades of coupling agents that may be advantageous.

In one example, Ken-React® LICA 12 may be combined with CaCO3, BaSO4, BaFerrite, Mg(OH)2, Wollastonite, TiO2, Silica, Clay-Calcined and polyolefins. Ken-React® LICA 38 may be combined with BaFerrite, Silica, Al(OH)3, Clay-Calcined, Wood Flour, Pecan Nut Flour and polyolefins. Ken-React® LICA 09 may be combined with Graphite and Coke and polyolefins.

Below is another example of a table for coupling agent selection for filler-containing layer (402).

| Functional | |
|---|---|
| Group | Thermoplastics |
| (Pyro-) | PE, PP, PVC, |
| phosphato | PA, PET |
| Benzene- | PE, PP |
| sulfonyl | |
| Ethylene- | TPU, EVA, CAB |
| diamino | |

Some additional coupling agents are as follows: aluminate, siloxane, and silane.

Organofunctinoal silanes are common and the effect is based on the chemical structure: X-(CH2)n-Si (OR)3 where X represents an organo-functional group that is compatible with the polymer matrix. The OR group is a methoxy or ethoxy group which is hydrolyzeable and provides chemical or physical bonds to the filler surface. However, some limitations with silanes in regards to unreactive polyolefins are common, but may be solved when the fillers are silane treated to work with PP and PE to improve dispersion. The most common silanes and the applications may include, for example, those listed below:

| Functional | |
|---|---|
| Group | Thermoplastics |
| Amino | PVC, PE, PP, PA, |
| Vinyl | PEVA, PE, PP |
| Methacryl | PE, PP |

Other coupling agents not listed may also be viable to produce the desired effect of coupling the filler to the binding agent without moving away from the spirit of the enclosed invention.

In some applications, the composite may be breathable. Breathable may be defined as permeable to vapor and impermeable to moisture.

In some embodiments, the breathable layer may be the filler-containing layer by using a binding agent that may be breathable, or the breathable layer may be coextruded with the filler-containing layer or the composite, or coated onto the surface of the filler-containing layer or composite, as a skin or surface. In other embodiments, the breathable layer may be a separate layer, attached or bonded to the surface of the filler-containing layer or composite. In these embodiments, the composite may be porous or substantially porous with a breathable skin coextruded or bonded to the surface, to impart both breathability and water-proofness.

Examples of vapor permeable and moisture impermeable materials may include a water vapor permeable polyurethane film formed from a hot melt moisture curing adhesive containing at least one isocyanate functional polyurethane (which may be a reaction product of a component that contains NCO groups and a diol component with at least one linear dihydroxy polyester, formed from a diacid constituent and a diol constituent, the diol constituent may be a dihydroxy poplyether having a weight average molecular weight of at least 1000, and the ratio of OH:NCO in the isocyanate functional polyurethane is between 1.0:1.6 and 1.0:2.6) (disclosed in U.S. Pat. No. 5,851,661, the content of which is incorporated herein by reference); a film layer formed from a composition of a non-curing thermoplastic composition containing ethylene methacrylic acid copolymer or a polyether block amide, and at least one diluent such as a plasticizer (disclosed in U.S. Pat. No. 6,432,547, the content of which is incorporated herein by reference); certain copolymers of ethylene vinyl acetate, ethylene n-butylacrylate carbon monoxide, ethylene vinyl acetate carbon monoxide, and combinations thereof; a substrate with a thermoplastic composition made with a non-contact coating method to produce a substantially continuous coating of a variety of copolymers (such as polyethylene, polypropylene, copolymers of olefins, especially ethylene, and (meth-) acrylic acid; copolymers of olefins, such as ethylene, and (meth-) acrylic acid derivatives of (meth-) acrylic acid esters; copolymers of vinylic compounds of vinyl carboxylates such as vinyl acetate; thermoplastic rubbers (or synthetic rubbers) such as styrene-isoprene-styrene, styrene-butadiene-styrene, styrene-ethylene/butylene-styrene and styrene-ethylene/propylene-styrene block copolymers available in commerce under the tradenames of Kraton®, Solprene®, and Stereon®; metallocene-catalyzed polymers, especially based on ethylene and/or propylene; polyolefins such as ethylene, polypropylene and amorphous polyolefins (atactic poly-alpha-olefins) such as Vestoplast® 703 (Huls); polyesters; polyamides; ionomers and corresponding copolymers; and mixtures thereof), as disclosed in U.S. Pat. Nos. 6,843,874 and 7,078,075, the content of which is incorporated herein by reference; or similar.

Some polymer surfaces or coating are inherently printable or may be made to be printable. Some fillers are found to aid in printability, as noted above. Breathable layer or surfaces may also be inherently or be made printable, if desired.

In another aspect of the invention and as discussed above, the ground filler-containing layer (200) may be created through a weaving process, similar to that used to make various types of fabrics as shown in FIG. 11. The ground filler material combined with the binding agent, such as a polymer, and similar ingredients may be extruded into individual threads 1301, which are then used to weave together to form a sheet or matte. The final material can be controlled by the type of pattern it is woven into, as well as the strand/thread diameter and thread count. In some cases the woven fabric may be post calendered with heat and pressure to in fact create a non-porous synthetic paper. In another version, woven fabric may be coated or bonded with a breathable layer, or a breathable layer may be non-contact extruded onto the surface of the woven fabric. Details of the non-contact extrusion method may be found in U.S. Pat. Nos. 6,843,874 and 7,078,075, the content of which is incorporated herein by reference, as mentioned above. In yet another version, the extruded thread(s) are tensilized to increase their linear strength. Tensilizing stretches and densifies the thread such that the tensilized thread 1301 has enhanced slip properties which reduces friction and may aid in processing of the finished product. In addition, tensilizing also enhances the suppleness and softness properties of the thread and final sheet or matte 1300 while simultaneously increasing the linear strength. This may allow for a reduction in thread thickness with increased mechanical properties, which may further allow for a reduction in weight. The final composite material may be recyclable and either renewable, biodegradable or otherwise could become biodegradable with additives and any filler type material that has a low density and low in cost combination that is either inherently printable and or could be surface modified to become printable would be a very advantageous combination for woven ground filler-containing layer 402 to the fiber-containing layer 401 creating pliable and machinable composite structure 400.

Ultimately, with the future moving towards a more environmentally and recycling friendly direction, a ground filler-containing layer that is recyclable, renewable, biodegradable or otherwise could become biodegradable with additives and any filler type material that has a low density and low in cost combination that is either inherently printable and or could be surface modified to become printable would be a very advantageous combination for filler-containing layer 402 to the fiber-containing layer 401 creating pliable and machinable composite structure 400.

Many synthetic polymers such as polyethylene, polystyrene and polypropylene are not generally regarded as biodegradable. This property makes them attractive as packaging materials, as they are resistant to water and air as a result of their molecular structures. Their molecular backbones of hydrogen and carbon bonded together in long entangled chains give them flexibility and strength and also prevented them from being susceptible to oxidation which can lead to degradation. For biodegradability to take place, these polymers need to be broken down into smaller fragments and the incorporation of oxygen functional group.

The incorporation of oxygen to create functional groups such as carboxylic acids, esters, alcohols or aldehydes can change these polymers from being hydrophobic to hydrophilic, or transforming the binding agent polymer to be more hydrophilic or less hydrophobic, thereby allowing them to absorb water, become susceptible to microorganisms and suffer degradation.

Bio-degradation may be a microbiological stage in which biodegradation of the fragmented polymer takes place. The molecular weight of the polymer is reduced during the first step to levels that will allow bacteria, fungi and algae to consume the carbon backbone fragments into their trophic process. The end chemical products of the biodegradation step are carbon dioxide, water, and a small quantity of minerals and biomass with no toxic or harmful residues to soil, plants or macro-organisms. Any additives that may cause this transformation may be added to these polymers to control the life of the composites made with these polymers. Some examples of additives include transition metal salts, which may be non-toxic and which may allow the additive to be used in materials for food packaging. Oxo-biodegradable type packaging is also ideal for frozen food packaging, as it can be kept for extended periods at low temperature, and can be tailored to quickly degrade when it becomes a waste product at normal temperatures.

In general, a composite may include a biodegradable additive of up to about 5% of, for example, up to about 3% of, more for example, a metal salt by weight of the binding agent. Such additives may impart affordable or little cost to the products made and may be processed on conventional machinery. Such additives are typically added to the mixture as a masterbatch, such that the metal salt is already pre-suspended or dispersed into a polymer pellet, as when purchased commercially.

Also, a non-biodegradable binding agent may also be combined with a biodegradable agent to produce a substantially biodegradable or compostable binding agent.

In one exemplary example, the d2w® Self-Destruct, Oxo-Biodegradable Plastic additive, manufactured by Symphony Plastics (Borehamwood, United Kingdom)and TDPA® manufactured by EPI Environmental Products Inc. (Vancouver, British Columbia, Canada) may be useful in the present invention, to impart or improve biodegradability. These additives may cause a non-biodegradable thermoplastic to become bio-degradable while still maintaining its recyclability. D2W technology is an additive which may be combined usually at a level of, for example, less than about 5%, more for example, about 1 to about 3%, with any blend of polyethylene or polypropylene resins during standard production processes. The additive causes the polymer degradation process to be predictable once the process is initiated. The process may be initiated with any combination of other additives into filler-containing layer 200. The calendaring process may be used to create filler-containing layer 200 from about 1 to about 90% filler loadings. However, 75% and higher amounts of higher density filler loadings are better suited for calendaring. At too high of loadings of filler, depending on the binding agent, a continuous phase of the binding agent may not be created. Extrusion or cast film process may work well with filler loading from about 1 to about 85% by weight of the layer, however, loadings of less than about 75% are well suited for extrusion or cast film process. At less than 85% filler loadings, processing of thin films would be advantageous utilizing a blown film process. The blown film tends to be somewhat of lower quality than cast film in terms of transparency and uniformity of gauge. Blown film gauge variations are common at ±7% but can be as high as ±15%. Other factor that affects the process used to create the filler containing layer may also be the filler density. At lower density fillers, greater loading levels of fillers may be achieved in the blown film process and extrusion process.

In one instance, a high % by weight loading of fillers extruded first before going into the calendaring process for final processing is one example of a hybrid process and would be similar to hot feed extrusion utilized in the rubber industry. Various types of equipment could be used to process highly filled materials, for example, a twin screw extruder, including intermeshing and non-intermeshing, gear pump extruder, disk extruders, drum extruder, spiral disk extruder, dispack extruder, single screw extruder, calandering machine, blown film tower, and vented extruder.

Cast film and sheet are commonly produced by extrusion of the melt onto chilled chrome rollers. The molten filler-containing layer mixture exits the die at an angle between 0 and 180 degrees onto the chill roll operating between 30 and 50 degrees Celsius, contacting the melt tangentially. The rolls are usually highly polished in order to create smooth, consistent surface properties of the resulting filler-containing layer. An air knife can be used to force the molten filler-containing layer mixture against the chill roll. The molten filler containing material solidifies as it passes over various chilled rollers before it is wound into a roll. Occasionally the extrudate may descend vertically into a quench tank of water where it solidifies. Furthermore, once being quenched the filler-containing layer may be dried and rolled up. Cast film variations of ±3% are common. A way to minimize the variations is to use a closed loop controller via sensors that may monitor the thickness and adjust the die gaps automatically via computer controls.

In addition, various coextrusion and non-contact extrusion methods may be employed for producing the filler-containing layer or composite.

The composition of the fiber-containing layer 300 may also be controlled to provide layer 401 in the composite structure 400 having the desired characteristics, such as the desired pliability and machinability of the structure 400. The fiber-containing layer 401 may have a basis weight of from about 50 to about 130 lbs/1000 sqft, a density of from about 200 to about 430 g/m², a thickness of from about 10 mil to about 30 mils, and a tensile strength of from about 125 to about 900 MD and about 55 to about 400 CD.

The fiber-containing layer 401 may include at least one of natural and synthetic fibers, and has desirable tensile strength and other characteristics that render the layer suitable for machining processes used to form storage article(s) 800 and 1200 and containers 900 and 1100 respectively. For example, the fiber-containing layer 401 may be in the form of a fiberboard layer, and even a paperboard layer, such as one of the various different types of paperboard roll and sheet materials that are known in the art. Examples of suitable fiberboard and/or paperboard materials include, for example, recycled folding boxboards (RFB), honeycomb cores, bleached kraft board, unbleached kraft board, such as C1S and C2S solid bleached sulfate boards (SBS), as well as coated recycled boards (CRB) and uncoated recycled boards, clay coated light black boards (CCLB) and triplex and duplex boards. The fiberboards and/or paperboards used for the fiber-containing layer 401 typically contain primarily cellulosic and/or wood pulp-based fibers, although they may also have a synthetic fiber content. Fiber-containing layer (401) may also be made from the following types of fibers: Lignocellulosics, White Jute, Tossa Jute, China Jute, Kenaf, Roselle, Sugar Cane, Bagasse, Wheat Straw, Hibiscus, Bark, Ramie, Hemp, Sunn Hemp, Flax, Reed, Bamboo, Paina, Piacava, Pineapple, Sisal, Sponge Gourd, Banana, Coir, Cotton, Curaua and seaweed. Some inorganic fibers that could be utilized to create fiber-containing layer (20) are as follows: PMF® Fiber from Sloss Industries. The fiber is called Sloss blowing wool and is made from slag rock. Processed from Slag wool, which is fiberized at temperatures exceeding 2,400° F., PMF® Fiber offers outstanding heat resistance, fire and wear resistance characteristics.

The fiber-containing layer 401 may also desirably include a relatively high level of recycled and/or post-consumer recycled fiber content. For example, the recycled folding boxboard and coated and uncoated recycled boards can contain 100% recycled content, of which up to 35% by weight is post-consumer recycled content. The triplex and duplex boards, which may be coated recycled boards having a high content of post consumer recycled fibers, can contain 100% recycled content and greater than 90% or 95% post-consumer recycled content, respectively.

The thickness of one or more of the layers 401, 402 may also be controlled to provide more or less pliability in the resulting composite structure 400 as well as machinability, with thinner layers typically being more pliable than thicker layers. The thicknesses of the layers 401, 402 are also selected such that the composite 400 formed therefrom is readily machinable. Furthermore, the thicknesses of the layers 401, 402 are also selected with regard to desired durability requirements, with thicker layers providing more durability in some embodiments over very thin layers. A suitable thickness of the ground filler-containing layer 402 that provides good pliability as well as durability and machinability of the composite structure 400 may be, for example, from about 2 to about 30 mils, more for example, as from about 2.6 mils to about 20 mils. A suitable thickness of the fiber-containing layer 401 can vary according to the density and tensile strength of the type of paperboard or fiber being used. For example, the thickness of the layer may be from about 14 mils to about 28 mils for paperboard types such as C1S and C2S SBS paperboard, recycled folding boxboard, unbleached kraft board, coated and uncoated recycled board, and folding box board, and may be from about 12 mils to about 23 mils for paperboard types such as triplex and duplex paperboards.

To create composite structure 400, layers 200 and 300 may be coupled together. In one instance, the fiber-containing layer 300 may be coupled to the ground filler-containing layer 200 by utilizing heat and pressure. This allows the top surface of the fibers to penetrate the backside of the ground filler-containing layer and causing them to co-mingle at interface 404. This may create a mechanical lock between the two layers that is substantial but also allows the composite structure to maintain its pliability and machinability. In another instance, the pliable composite structure 400 is formed when adhesive is applied to a surface of one or more of the layers 402, 401 such as for example surface 301 of the fiber-containing layer 300. In this version, the adhesive may be applied substantially to the entire interface surface 404 of fiber-containing layer 401 to ensure bonding of the layers across the entire interface surface between layers 402 and 401. The processing parameters and adhesives selected under which coupling of the layers 402 and 401 is carried out can be selected to provide optimum adhesion of layers 402 and 401 to one another across their entire adjacent interface. A typical hot application gluing process in bonding layers 200 and 300 is with an adhesive having a viscosity of from about 650 cP to about 1,500 cP at a temperature of from about 295° F. to about 385° F. and a typical cold application process including bonding the layers with an adhesive having a viscosity of from about 950 cP to about 2,200 cP at a temperature of from about 27.5° C. to about 30° C. may be used. As such a pressure sensitive adhesive may also be utilized.

In some cases, an adhesive may not adhere well to ground filler-containing layer 402 and a surface treatment may be carried out for ground filler-containing layer 200 to increase the ability of the adhesive to couple to both the ground filler-containing layer 200 to the fiber-containing layer 300. Surface treatment generally produces polar groups on the surface of the ground filler-containing layer 200 at either surface 202 or 201 which increases its ability to bond to inks and adhesives. This process can also remove from the surfaces contaminants which may interfere with adhesion. Corona discharge is most often utilized when polymers are present in the surface being treated. Corona discharge could be applied to either surface 202 prior to layer 200 being coupled to layer 300 or could be applied to surface 403 once layer 402 is part of the composite. In doing so, it is possible to improve the printability and bondability of various types of ground filler-containing layers. For most solvent based printing, polymers are treated to 36 to 40 dynes/cm; water based inks usually require 40 to 44 dynes/cm. It is noted that some laminating and coating applications require surface energies of 50 dynes/cm or more.

In yet another embodiment, there exists synthetic paper(s) that could be substituted as the ground filler-containing layer (402) described in composite structure (400) and composite structure (500). Some examples that could be used are as follows: Polystar synthetic paper by Tai-Sanki of Tawian, Pro-Print Synthetic paper, Trans Tear Resistant Snythetic paper, Tyvek® Spunbonded Olefin, Teslin® Synthetic sheet, MXM® synthetic paper, LaserEase Composite Sheet by Transilwrap, Polyart® Synthetic paper by Polyart, Yupo Synthetic Paper by Yupo® Corporation of Japan, Kimdura® Synthetic Paper from Neenah Paper Inc of Georgia-USA, EPSON Enhanced Adheasive Synthetic Paper by Seiko Epson Corporation of Japan, Biodegradable synthetic paper—NatureFlex™ D-NE, NatureFlex™ NVS and Natureflex™ NM by Innovia Films of the United Kingdom and Bi-axially oriented Polypropylene (BOPP). These are just a few examples of synthetic papers or films that could be coupled to fiber-containing layer 401 to create composite structure 400.

A pliable sheet of composite structure 400 may be formed into the shape of a box or storage article 800 for example by performing the milling step and other processing steps, and by cutting the structure into the desired shape, followed by folding and/or creasing the sheet, either manually or by machine, such as via an automated cartoning process. The box 800) may be in the form of a cube, rectangular or other box shape and may or may not have a lid. Other types of boxes similar to box 800 or similar packaging and shipping containers may also be made from composite structures 400, 500, 600, and 700 respectively.

Composite structure 400 may be used to form most of an envelope or shipping container 900 for companies such as FEDEX and UPS to ship objects or documents. The mailer may be fabricated by using a series of folding, creasing and adhesive steps to create the desired shipping container geometry.

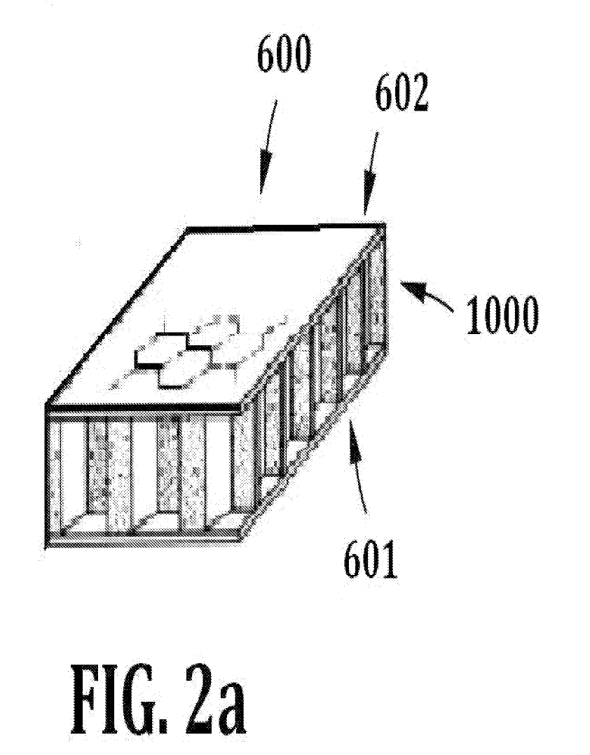

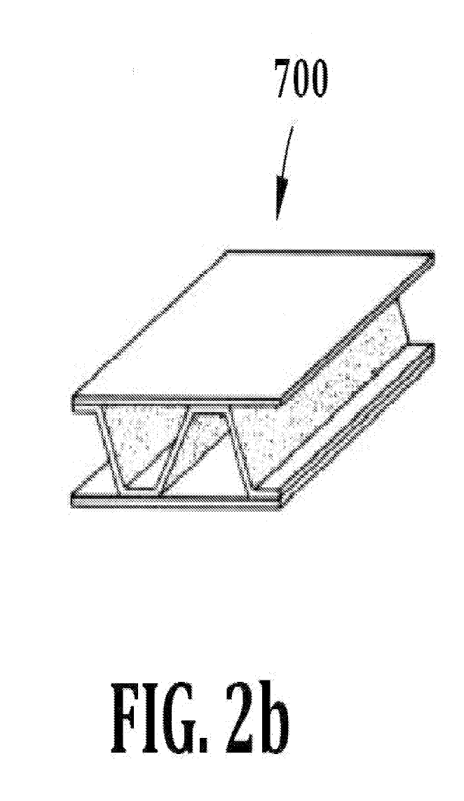

In another version, the pliable sheet or roll 1001 of composite structure 400 or 500 may be formed into the shape of a structured core material such as a honeycomb sandwich 600 or corrugated core 700 type as shown in FIGS. 2a and 2b, respectively. Honeycomb core 1000 types typically have openings in the out of-plane direction and provide a bi-directional support for skins 602, 601. Skins 602 and 601 may be made from composite structures 400 or 500. Honeycomb sandwich materials can offer weight and cost savings due to their excellent performance to weight ratio. Most honeycombs are adhesive bonded expanded cores 1000. Lines of adhesives 1002 can be placed evenly distributed on the pliable flat stacked sheets 1003 of composite structure 400, 500 or unimpregnated low cost papers. The distance between each adhesive line controls the size of the corrugation spacing. In one example, many of the pliable flat sheets of the composite structure may be stacked together and adhesive cured to form a block 1004. Individual strips 1005 are then cut from this block 1004 and the strips 1005 are pulled apart, thus expanding the stack into a hexagonal honeycomb core 1000. The width of the individual strip 1007 controls the overall height of the core once it is expanded 1006 thus would affect its mechanical properties in the final composite structure. Any remaining residual stresses in the honeycombs can be relaxed after expansion by controlled application of heat and moisture. The cycle time of conventional honeycomb production is typically more time consuming at lower cell sizes for low cost applications. Cell size and core height of the honeycombs made out of unimpregnated low cost papers are usually above 10 mm for these low cost applications. Low cost paper honeycombs for example, above 10 mm, are mainly used for door filling and inner packaging protection elements and in the automotive industry have been used as side impact energy absorption elements in doors. Low cost honeycomb cores made from composite structure (500) would be an improvement over paper honeycombs in that they could be tailored to be resistance to heat, fire, and be inherently resistant to tearing, wrinkling, scuffing and moisture, as well as resistance to infiltration by rodents and pests. Coupling a layer of composite structure 400 or 500 to the top 602 and or bottom 601 of honeycomb core 1000 shall produce honeycomb sandwich 600.

Machinery for the automation and adaptation of the traditional expansion process for thermoplastic material has been built by Versacore Inc. First strips are cut from the roll 1008, stacked 1009 and then fed into the machine. Expansion of the welded stack occurs at 1011 utilizing Versacore's Thermostack™ machinery. Once the stack is expanded, the honeycomb structure is complete 1000. The thermoplastic material traditionally used can be replaced by composite structure (500) at a lower cost than with the existing thermoplastic material with similar mechanical properties, welding properties, while also being environmentally friendlier than thermoplastic material alone. The advantage of using composite structure 500 over composite structure 400 is that composite structure 500 can be welded on both sides of the composite while composite structure 400 can only be welded on one side.

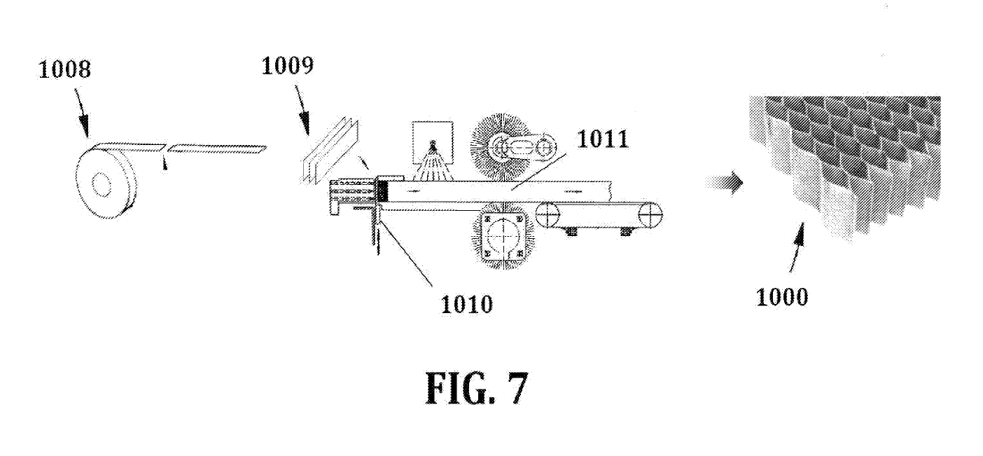

Various examples of cost effective methods for coupling sheets 1009 of composite structure 500 to itself at location 1010 in the continuously produced honeycomb process, as shown in FIG. 7, are as follows: Heat sealing, bar or thermal sealing, impulse sealing, Hot wire or hot knife sealing, ultrasonic sealing, friction sealing, hot gas and contact sealing, and radiant sealing.

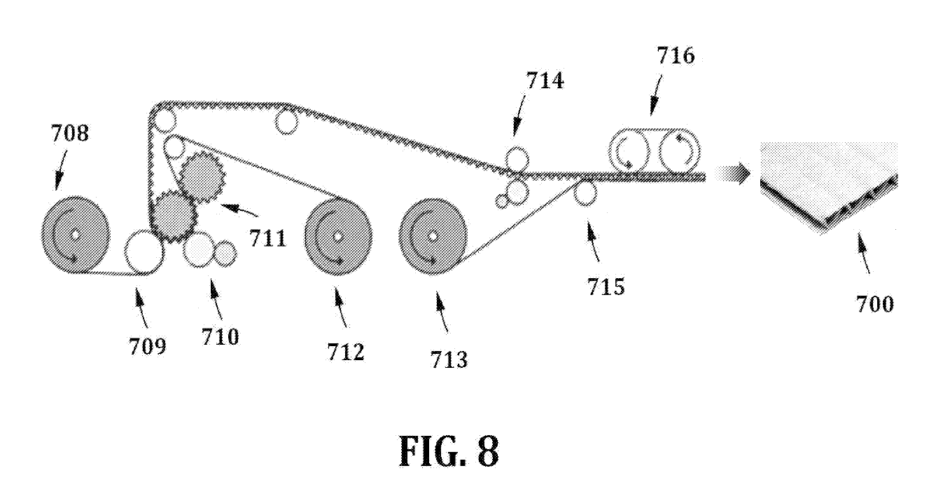

The packaging industry has a very high demand on the cost effectiveness of production processes. The most efficient production technology is the continuous in line production processes in the production of the corrugated cardboard for the packaging industry. By combining unimpregnated low cost papers folded between two layers of composite structure 400, as shown in FIG. 8, one may achieve an improved printable, water resistance, environmentally friendly, pliable, foldable, scorable, bendable, corrugated panel or pallet sheet.

First, the roll of composite structure 400 at 708 is feed into the pressing roller 709. At the same time the flute/core roll 712 is unwound and feed through the corrugation rollers at interface 711 to create corrugated layer 707 and then passed over the adhesive roller 710 and adhesive applied to 702 flutes. Next the corrugated layer 707 is pressed and coupled to the first layer of composite structure 400. The material then passes over guiding rollers and onto another gluing roller 714 where adhesive is applied to 701 flutes. Just after this occurs, another roll of composite layer 400 is applied to the subassembly at interface 701 as it is pressed through roller 715. Next the entire assembly is ran through the drying belt 716 and cut to size to create a unique, printable, water resistant, foldable, scorable, bendable, corrugated panel 700. Fiber-containing layer 707 may be in the form of a fiberboard layer, and even a paperboard layer, such as one of the various different types of paperboard roll and sheet materials that are known in the art.

In yet another example, a pliable sheet of composite structure 400, 500 and corrugated panel 700 is formed into the shape of container 1100 or tube 1200 for example by performing the milling step and other processing steps, and then by cutting the structure into the desired shape, and then folding, rolling and/or creasing the sheet, either manually or by machine and finally coupling the material utilizing an adhesive into the final geometry. Container 1100 is formed by creating the bottom of the container 1101 and attaching it to the completely formed top of container 1102. It is advantageous to use composite structure 500 over composite structure 400 for the container in that while utilizing of composite structure 500, the inside may be resistant to water and the outside may also be printable. Such double or triple layer composite structure 500 can have a basis weight of from about 66 lbs/1000 sqft to about 175 lbs/1000 sqft, a density of from about 216 g/m³ to about 880 g/m³, a tensile strength of about 125 to about 900 MD and about 55 to about 400 CD, as measured by the ASTM D5342-97 Standard, and a thickness of from about 12 mils to about 32 mils.

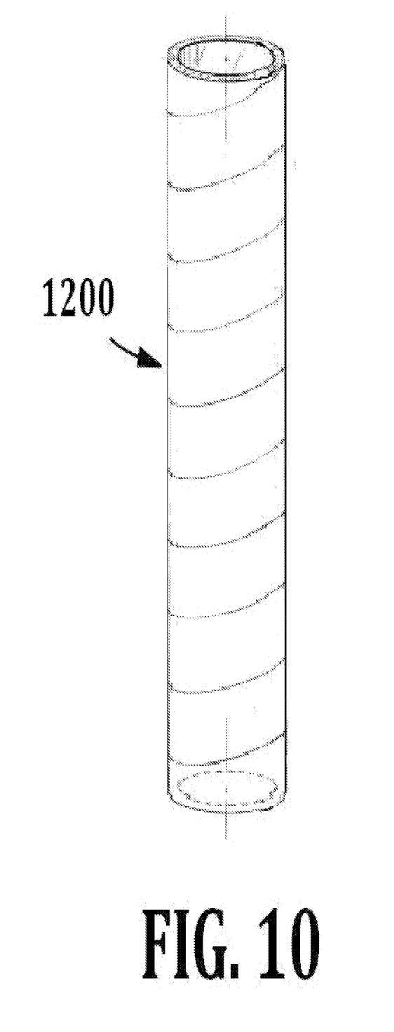

Utilizing composite structure 400 to form the cup may allow for water resistance and excellent printability to be either on the inside or outside only. Container 1100 could be, for example, used as a drinking cup, flower pot, medical packaging or other food storage container. A pliable sheet of composite structures 400 or 500 or corrugated panel 700 is also formed and sized to create tube 1200 shown in FIG. 10. The tube could be used for example as a shipping tube for various articles, as well as for a storage article for food and fluids, center core for winding articles and or be used for concrete forming.

In other embodiments, the composite may be breathable, as discussed above. The breathable layer may be present on top of a porous filler-containing layer. The breathable layer is also a waterproof layer and may also be printable or writable, depending on the composition of the layer or any surface treatment involved thereof, as noted before.

The filler-containing layer may also be a micro-porous layer, or the composite may additionally be coated with a micro-porous layer. The micro-porous layer may also be breathable. Some microporous layer may also be modified to impart tamper-resistant features. Information or indicia may be printed on the microporous layer to indicate tampering when occurred.

As also discussed above, conductivity may also be imparted to the composite. An electrically conductive layer may be present above or beneath the filler-containing layer. The conductive layer may include electrically conductive tapes and films which may be formed of a conductively loaded resin-based material, as also discussed above. The resin material may be any of the polymers mentioned above for the binding agent. Conductive materials may include micron-sized or submicron-sized conductive powder(s), conductive fiber(s), or a combination of conductive powder and conductive fibers in a base resin host or matrix. In addition to the conductive particles mentioned above, a conductive polymer, such as polystyrene sulfonate, poly(ethylene-dioxythiophene) or PEDT, PEDT doped with polystyrene sulfonate (PEDT/PSS), polyaniline, polypyrrole, poly)phenylene vinylene), polyarylene polymers such as polyspirobifluorene, and poly(3-hexylthiophenepolysulfones may also be used, either as an additive or as a component of the binding agent. Also, conductive polymer coated particles, such as carbon powders, may be used. Examples include polyaniline- and polypyrrole-coated carbon powders.

In general, the percentage by weight of the conductive powder(s), conductive fiber(s), or a combination thereof may be between about 20% and about 50% of the weight of the conductively loaded resin-based composition.

Composites having EMI (electromagnetic interference) shielding characteristics may also be useful in the present invention. One example may be the use of a material such as the trademarked “ElectriPlast™”. ElectriPlast™ is an electrically conductive resin based material that may be processed into a film, utilizing a micron-sized conductive material to create a material that is as electrically conductive as metal.

The composites may also have antistatic property. This may be done by adding an electrostatic discharge reduction additive to the filler-containing layer, for example, to reduce electrostatic charges commonly generated by friction, and or during porcession, as noted before. For example, fatty acid esters, ethoxylated amines, alkyl sulfonates, ethoxylated amine, ethoxylated alcohol, alkylsulfonate ethoxylated amines, diethanolamides, or other similar compounds, may be added at a concentration of about 0.1 to about 3% by weight of the layer, either to the filler, the binding agent or as a coating to the composite.

It is contemplated that any of the imparted antimicrobial, conductive, EMI shielding, antistatic, heat sealability, breathability, etc, properties, maybe present alone or in combination with any other properties.

Some specific examples may include those listed in the following:

% by weight

| Fillers | Talc | Calcium | titanium | Calcium |
|---|---|---|---|---|
| | 7% | Carbonate | dioxide | Silicate |
| Filler % | | 35% | 3% | 11.8% |

| | |
|---|---|
| Binding Agent | HDPE |
| Binding Agent % | 40% |
| Lubricant | N-oleyl |
| | palmitamide |
| Lubricant % | 0.40% |
| OXO-Biodegradable | Oxo-Biodegradable |
| Additive | additive |
| OXO-Biodegradable | 1.20% |
| Additive % | |
| Coupling agent | beta-(3,4- |
| | epoxycyclohexyl)ethyltrimethoxy- |
| | silane |
| Coupling agent % | 0.80% |
| Antistatic agent | N,N-bis (2-hydroxyethyl)stearyl |
| | amine |
| Antistatic agent % | 0.80% |

% is by weight

| | | | | |
|---|---|---|---|---|
| Fillers | Talc | Calcium | titanium | Calcium |
| | 7% | Carbonate | dioxide | Silicate |
| Filler % | | 35% | 3% | 37.55% |

| | |
|---|---|
| Binding Agent | HDPE |
| Binding Agent % | 15% |
| Lubricant | N-oleyl |
| | palmitamide |
| Lubricant % | 0.40% |
| OXO-Biodegradable | Oxo-Biodegradable |
| Additive | additive |
| OXO-Biodegradable | 0.45% |
| Additive % | |
| Coupling agent | beta-(3,4- |
| | epoxycyclohexyl)ethyltrimethoxy- |
| | silane |
| Coupling agent % | 0.80% |
| Antistatic agent | N,N-bis (2-hydroxyethyl)stearyl |
| | amine |
| Antistatic agent % | 0.80% |

% is by weight

| | | | | | | |
|---|---|---|---|---|---|---|
| Fillers | Talc | Calcium | Titanium | Aluminum | Calcium | Magnesium |
| | 7% | Carbonate | dioxide | hydroxide | silicate | Hydroxide |
| Filler % | | 35% | 3% | 15% | 15% | 7.55% |

| | |
|---|---|
| Binding Agent | HDPE |
| Binding Agent % | 15% |
| Lubricant | N-oleyl |
| | palmitamide |
| Lubricant % | 0.40% |
| OXO- | Oxo-Biodegradable |
| Biodegradable | additive |
| Additive | |
| OxO- | 0.45% |
| Biodegradable | |
| Additive % | |
| Coupling | Titanate Ken-React ® LICA |
| agent | 12 |
| Coupling | 0.80% |
| agent % | |
| Antistatic | N,N-bis (2-hydroxyethyl)stearyl |
| agent | amine |
| Antistatic | 0.80% |
| agent % | |

A twin screw extruder may be used to first pelletize the various ingredients into pellets. Next, the pellets may be extruded through a twin screw extruder to create a thin film of about 100 microns thick which may be rolled up into a roll. Next, the filler containing layer may be laminated onto some recycled fibers using an adhesive. The processing temperatures for HDPE in the extruder are recommended to be between about 350 to about 525° F. The actual processing temperature used will depend on the binding agent used.

Examples of suppliers of the ingredients may include: (talc) Rio Tinto PLC of the United Kingdom, (calcium carbonate and HDPE) Heritage plastics of Picayune, Miss. USA, (AP-Silane 53 beta-(3,4-epoxycyclohexyl)ethyltrimethoxy-silane) Advanced Polymer Inc, of Carlstadt, N.J., (N,N-bis (2-hydroxyethyl)stearyl amine and N-oleyl palmitamide) PCC Chemax Inc of Piedmont S.C., USA, (Calcium Silicate) NYCO Minerals Inc of Willsboro, N.Y., USA, (Titanate coupling agent) Kenrich Petrochemicals of Bayonne, N.J. USA, (Aluminum hydroxide) Alcan Chemicals, Bucks, United Kingdom, (Magnesium Hydroxide) Microfine Minerals Ltd, Raynesway, United Kingdom, and so on.

While exemplified embodiments of the invention have been described and illustrated above, it should be understood that these are exemplary of the invention and are not to be considered as limiting. Accordingly, the invention is not to be considered as limited by the foregoing description.

What is claimed is:

1. A composite material comprising:
a fiber-containing layer comprising at least one of natural and synthetic fibers, said fiber-containing layer having at least one surface; and
a filler-containing layer coupled to the fiber-containing layer substantially continuously across the at least one surface of the fiber-containing layer, said filler-layer comprises fillers having particle size of from about 0.01 to about 50 microns, in an amount of from about 50% to about 90% by weight; wherein the filler-containing layer comprises at least one binding agent present as a continuous phase in the layer in an amount of from about 10% to about 50% by weight;

2. The composite material according to claim 1, wherein said pliability of the composite material is at least 15% higher than that of the fiber-containing layer alone.

3. The composite material according to claim 1 wherein the filler comprises wollastonite, hydrated and nonhydrated magnesium Silicate, barium sulfate, barium ferrite, magnesium hydroxide, magnesium carbonate, aluminum trihydroxide, aluminum hydroxide, natural silica, clay-calcined, muscovite, nepheline-syenite, feldspar, calcium suphate, clay-calcined, muscovite, nepheline-syenite, feldspar, calcium suphate, cristobalite, dolomite, silton, mica, hydratized aluminum silicates, coke, carbon black, pecan nut flour, wood flour, fly ash, starch, titanium dioxide, barium carbonate, terra alba, selenite, feldspar, nepheline-syenite, muscovite, pectolite, chrysotile, borates, and sulfates, or combinations therefore.

4. The composite material according to claim 1, wherein said binding agent comprises Polyolefin, thermoplastic elastomers, thermoplastic vulcinates, polymers and copolymers of polylactic acid, polystyrene, polyester, polyoxamethalyne, cellulosics, polyamides, polyamideimides, polybutylene-terephthylate, polyester elastomers, linear low density polyethylene, thermoplastic polyurethane, bi-axially oriented polypropylene, ethylene copolymers, Polyvinylchloride, block copolyetheresters derived from hydroxyl-terminated polyethers, polycarbonates, polyestercarbonates, polyketones, polysulfones, polyethersulfones, polyetherketones; unsaturated polyesters derived from copolyesters of saturated and unsaturated dicarboxylic acids, crosslinked acrylic resins derived from substituted acrylates, starch, cellulose, polyhydroxy alcanoates (PHA), polycaprolactone (PCL), polybutylene succinate (PBS)), polymers and copolymers of N-vinylpyrrolidone, polymethylpentene, Methyl methacrylate-acrylonitrile-butadiene-styrene, polytetrafluoroethylene, polyphenylene oxide, polyphenylene sulfide, polyacrylonitrile, polycyanoacrylate, polyvinylpyrrolidone, polydicyclopentadiene, polyimides, aramids, polybutadiene, acrylonitrile-styrene, paracyclophane, parylene, ethylene vinyl alcohol, or combinations thereof.

5. The composite material according to claim 1 further comprising a coupling agent selected from the group consisting of titinate, aluminate, siloxane, silane, zirconate and combinations thereof.

6. The composite material according to claim 1 wherein said filler-containing layer is substantially transparent or semi-transparent.

7. The composite material according to claim 1 further comprising a biodegradable additive in an amount up to about 3%.

8. The composite material according to claim 1 wherein the filler-containing layer comprises at least one antimicrobial agent, an antistatic agent, a conductive additive, or combinations thereof.

9. The composite material according to claim 1 wherein the fiber-containing layer comprises bleached or unbleached kraft board, recycled folding boxboard, folding box board, coated recycled board, uncoated recycled board, Lignocellulosics, White Jute, Tossa Jute, China Jute, Kenaf, Roselle, Sugar Cane, Bagasse, Wheat Straw, Hibiscus, Bark, Ramie, Hemp, Sunn Hemp, Flax, Reed, Bamboo, Paina, Piacava, Pineapple, Sisal, Sponge Gourd, Banana, Coir, Cotton, Curaua, sloss wool, seaweed or combinations thereof.

10. The composite material according to claim 1 wherein the fiber-containing layer has a density of from about 200 to about 430 g/m2 and a tensile strength of from about 125 to about 900 MD and about 55 to about 400 CD.

11. The composite material according to claim 1, wherein the composite is shaped to form a storage article.

12. The composite material according to claim 11 wherein the Storage article is selected from the group consisting of a retail box, a shipping box, and a pallet sheet.

13. The composite material according to claim 1 wherein the composite is shaped to form a sandwich core material.

14. The composite material according to claim 13 wherein the sandwich core material is in the shape of a honeycomb core or a honeycomb sandwich.

15. The composite material of claim 1 wherein said binding agent is biodegradable, compostable, or recyclable.

16. A composite comprising:
a fiber-containing layer comprising at least one of natural and synthetic fibers, said fiber-containing layer having two surfaces; and
a filler-containing layer coupled to the fiber-containing layer substantially continuously across one of the surfaces of the fiber-containing layer, said ground filler-layer comprises at least one binding agent and at least one additive capable of converting a non-biodegradable binding agent into a biodegradable binding agent;
wherein the at least one binding agent is present as a continuous phase in the layer in an amount of from about 10% to about 50% by weight.

17. The composite of claim 16 further comprising a second filler-containing layer bonded to the other of the surfaces of the fiber-containing layer.

18. The composite of claim 16 wherein the filler-containing layer comprises particles sized from about 0.01 to about 25 microns, and present in an amount of from about 50% to about 90% by weight.

19. The composite of claim 16 wherein the filler-containing layer further comprises a coupling agent in the amount of 0.2% to 3% by weight of the filler.

20. The composite of claim 19 wherein said coupling agent is selected from the group consisting of titinate, aluminate, siloxane, silane, zirconate and combinations thereof.

21. The composite of claim 16 wherein said biodegradable additive is capable of fragmenting the polymeric chain.

22. The composite of claim 16 wherein said biodegradable additive is capable of transforming the binding agent to become more hydrophilic.

23. The composite of claim 16 wherein said biodegradable additive comprises up to 3% of a metal salt.

24. A composite structure comprising;
a fiber-containing layer comprising at least one of natural and inorganic fiber, the fiber-containing layer having a surface; and
a filler containing-layer applied to the fiber-containing layer, the ground filler layer being bonded to the fiber-containing layer substantially continuously across the surface of the fiber-containing layer;
wherein said filler has a density of less than about 3.0 g/cc and said filler layer comprises at least one binding agent present as a continuous phase in the layer.

25. The composite structure of claim 24 wherein said filler has a particle size from about 0.01 to about 25 microns.

26. The composite structure of claim 24 wherein said binding agent comprises a biodegradable, compostable, or recyclable polymer.

27. The composite structure of claim 24 wherein said filler containing-layer further comprises a conductive agent, an antimicrobial agent, an antistatic agent or combinations thereof.

28. The composite structure of claim 24 wherein said filler containing-layer is heat sealable.

29. The composite structure of claim 28 wherein said antimicrobial agent is covalently bonded to the filler or the binding agent.

30. The composite structure of claim 24 wherein said filler containing-layer further comprises a coupling agent.

31. The composite structure of claim 24 wherein said filler-containing layer is woven.

32. The composite structure of claim 1 wherein said composite is breathable.
